(19) United States
(12) Patent Application Publication
(10) Pub. No.: US 2026/0100734 A1
(43) Pub. Date: Apr. 9, 2026

(54) METHODS, APPARATUSES AND SYSTEMS RELATED TO ENABLING CSI-BASED NEAR FIELD SPOT BEAMS

(71) Applicant: InterDigital Patent Holdings, Inc., Wilmington, DE (US)

(72) Inventors: Salah Elhoushy, LaSalle (CA); Patrick Svedman, Stockholm (SE); Afshin Haghighat, Ile-Bizard (CA); Allan Yingming Tsai, Boonton, NJ (US); Chia-Hung Wei, Chesterbrook, PA (US); Yifan Li, Conshohocken, PA (US); Ravikumar Pragada, Warrington, PA (US)

(21) Appl. No.: 18/906,608

(22) Filed: Oct. 4, 2024

(51) Int. Cl. H04B 7/0456

(52) U.S. Cl. CPC H04B 7/0456

(57) ABSTRACT

In an embodiment, a method implemented in a WTRU comprises receiving a first message comprising first information indicating a configuration of a set of precoders, a set of correction factors, association between each precoder of the set of precoders with at least one correction factor from the set of correction factors, and at least one RS; receiving at least one reference signal; determining a first precoder based on at least one measurement on the at least one RS; determining a subset of correction factors associated with the first precoder; determining a correction factor from the subset of correction factors; determining a second precoder based on the first precoder and the determined correction factor; and transmitting a second message comprising second information indicating the second precoder.

### FIELD OF THE INVENTION

The present disclosure is generally directed to methods and procedures related to enabling CSI-Based near field spot beams.

### BACKGROUND

Massive MIMO may be one of the most successful technologies in recent wireless communication systems, such as 5G. In a traditional massive multiple-input multiple-output (MIMO) system, transmission and reception point (TRP) may be equipped with a large number of antennas. Legacy massive MIMO communication systems may be typically designed based on the assumption that the transmission/reception happens in the far field (FF), which means that the radio wave propagation can be accurately modeled as a planar wave. However, with increasingly large TRP arrays in relation to the wavelength, and with denser TRP deployments, the likelihood of user equipments (UEs) being located within a Fresnel region in which near field (NF) propagation takes place increases. The Rayleigh distance may be used as the demarcation boundary between the Fresnel zone and the far (Fraunhofer) zone.

In NF, the planar wave approximation may be no longer accurate and electromagnetic wavefronts must be accurately modelled as spherical waves. Accordingly, applying legacy FF transmission/reception techniques for a UE located in the NF region may lead to performance losses, e.g., reduced array gains.

There is a need to enhance wave propagation model in NF situation.

### SUMMARY

In an embodiment, a method, implemented in a wireless transmit/receive unit (WTRU) may comprise a step of receiving a first message comprising first information indicating a configuration of a set of precoders, a set of correction factors, association between each precoder of the set of precoders with at least one correction factor from the set of correction factors, and at least one reference signal (RS). The method may further comprise a step of receiving, from a transmission reception point (TRP), at least one reference signal from the configured at least one RS. The method may further comprise a step of determining a first precoder from the set of precoders based on at least one measurement on the at least one RS. The method may further comprise a step of determining, from the set of correction factors, a subset of correction factors associated with the first precoder. The method may further comprise a step of determining a correction factor from the subset of correction factors. The method may further comprise a step of determining a second precoder based on the first precoder and the determined correction factor; and a step of transmitting, to the TRP, a second message comprising second information indicating the second precoder. The first precoder may be a far field precoder and the second precoder may be a near field precoder. The correction factor may comprise a phase correction vector to be applied on the first precoder. Determining the second precoder may comprise element-wise multiplication between a first precoder vector and the phase correction vector of the correction factor; wherein the first precoder comprises the first precoder vector. The second information may indicate one or more first indices related to the first precoder and one or more second indices related to the determined correction factor

The correction factor may be determined from the subset of correction factors based on at least one additional measurement on the received at least one RS, wherein the at least one additional measurement may comprise a measurement of reference signal received power.

The method, wherein the first information further indicates one or more subset of correction factors from the set of correction factors, and wherein each subset of correction factors is associated with a distance range between the TRP and the WTRU, may comprise a step of determining a distance range between the TRP and the WTRU based on the received at least one reference signal; and a step of determining the subset of correction factors from the set of correction factors based on an association between the determined distance range and the subset of correction factors.

The method, wherein the first information further indicates at least one minimum correction factor, at least one maximum correction factor, at least one quantization level, and association between each precoder of the set of precoders and a minimum correction factor, a maximum correction factor, and a quantization level, may comprise a step of determining the subset of correction factors based on the associated minimum correction factor, maximum correction factor, and quantization level with the first precoder.

The method may further comprise a step of determining the subset of correction factors based on a determined distance range between the TRP and the WTRU based on the received at least one reference signal, and based on a minimum or a maximum correction factor, and a quantization level associated with the first precoder.

The first information may further indicate one or more subset of correction factors of the set of correction factors, an association of each correction factor of the subset of correction factors with result of measurement on the at least one RS, and wherein the determination of the correction factor from the set of correction factors may be based on an association of the result of at least one additional measurement with the correction factor.

The configuration may be a channel state information (CSI) configuration, wherein the configuration of the at least one reference signal may be a configuration of a downlink CSI-RS, and wherein receiving at least one RS may comprise receiving a downlink control information (DCI) to trigger an aperiodic CSI measurement on the configured DL CSI-RS.

In an embodiment, a wireless transmit/receive unit (WTRU) comprising a processor, a transmitter, a receiver and a memory, may be configured to receive a first message comprising first information indicating a configuration of a set of precoders, a set of correction factors, association between each precoder of the set of precoders with at least one correction factor from the set of correction factors, and at least one reference signal (RS). The WTRU may be configured to receive, from a transmission reception point (TRP), at least one reference signal from the configured at least one RS. The WTRU may be further configured to determine a first precoder from the set of precoders based on at least one measurement on the at least one RS. The WTRU may be further configured to determine, from the set of correction factors, a subset of correction factors associated with the first precoder. The WTRU may be further configured to determine a correction factor from the subset of correction factors. The WTRU may be further configured to determine a second precoder based on the first precoder and the determined correction factor; and to transmit, to the TRP, a second message comprising second information indicating the second precoder.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a line of sight (LoS) transmission from a large antenna array according to an embodiment;

FIG. 3 is a block diagram illustrating an example of a non-LoS transmission from a large antenna array according to an embodiment;

FIG. 4 is a block diagram illustrating an example of a construction of one or more subsets of far field (FF) beams from a 2-D codebook of discreet Fourier transform (DFT) beams according to an embodiment;

FIG. 5 is a block diagram illustrating an example of an angle-based subsets of beamfocusing parameters;

FIG. 6 is a block diagram illustrating an example of an association between subsets of beamfocusing parameters and subsets of FF beams according to an embodiment;

FIG. 7 is a block diagram illustrating an example of an association between different subsets of FF beams with the same set/subset of beamfocusing parameters according to an embodiment.

FIG. 8 is a block diagram illustrating an example of a region-based subsets of beamfocusing parameters according to an embodiment;

FIG. 9 is a block diagram illustrating an example of a configured angle-based parameters for constructing one or more angle-based subsets of beamfocusing parameters according to an embodiment;

FIG. 10 is a flow chart diagram illustrating an example of a method, implemented in a WTRU, for determining and reporting of a Near Field (NF) beam comprising a FF beam and a selected beamfocusing parameter from a configured subset of beamfocusing parameters according to an embodiment;

FIG. 11 is a flow chart diagram illustrating an example of a method, implemented in a WTRU, for determining and reporting of a NF beam comprising a FF beam and a selected beamfocusing parameter from a determined subset of beamfocusing parameters according to an embodiment;

FIG. 12 is a flow chart diagram illustrating an example of a Distance/Angle-aided WTRU method for determining a NF beam; and

FIG. 13 is a flow chart diagram illustrating an example of a method, implemented in a WTRU, for determining and reporting of a NF beam according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

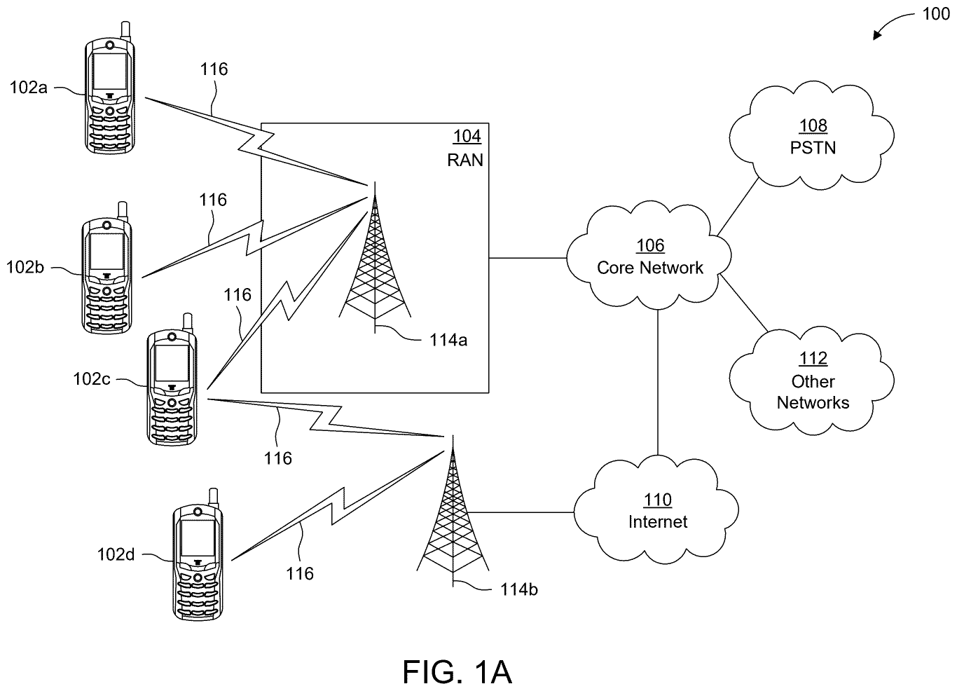

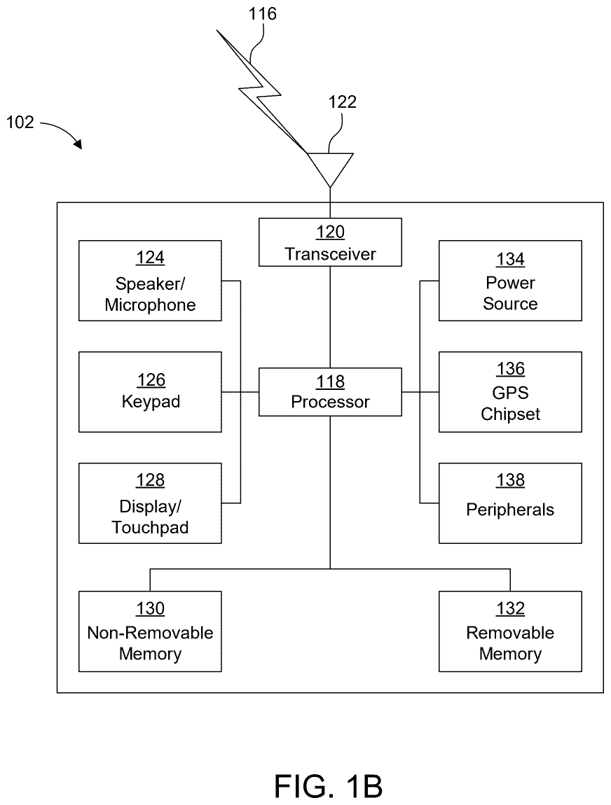

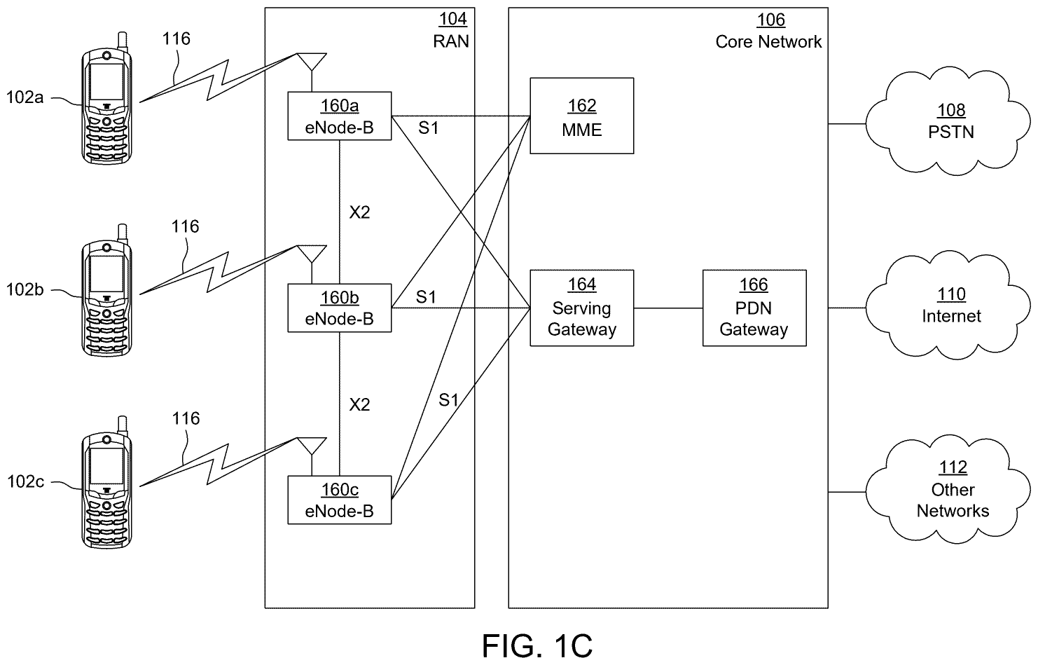

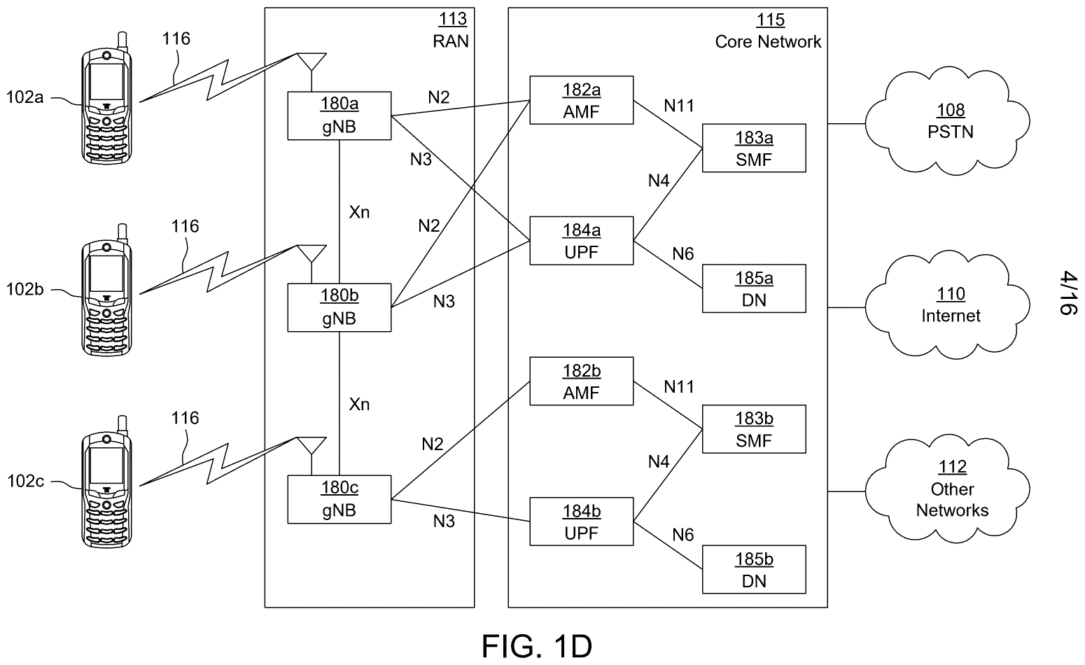

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an cNode-B (cNB), a Home Node-B (HNB), a Home cNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home cNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), an universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the cNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the cNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more cNode-Bs 160a, 160b, 160c substantially simultaneously. In the non-standalone configuration, cNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, cNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In classical far-field beamforming, a beam may be formed that focuses energy on a particular spatial direction. The same beamforming gain may be achieved, regardless of the distance between a transmitter and a receiver, as long as the far-field approximation is applicable. Thus, angle-based spatial division multiple access (SDMA) techniques may be applied for multi-user MIMO (MU-MIMO) scenarios to serve multiple users simultaneously.

In the near field, on the other hand, it may be possible to achieve a beamforming gain dependent on both the spatial direction and the distance, called the focus distance. The generation of a distance-dependent beam may be called beam focusing and the resulting beam may be called a spot beam. The use of beam focusing cannot only enable high beamforming gain in the NF but may also reduce the burstiness of inter-WTRU interference between WTRUs with same or different spatial directions. Thus, location division multiple access (LDMA) can be applied for MU-MIMO scenarios to serve multiple users simultaneously.

LDMA may be more suitable multi-user multiple access compared with conventional angle-based SDMA since LDMA can achieve higher spectral efficiency per WTRU, may serve larger number of users simultaneously over the same resources, and may improve the system capacity when WTRUs operate in the NF region

In 5G New Radio (NR), channel state information (CSI) may be used for achieving the anticipated performance gains of massive MIMO systems, including high transmission diversity, high spatial multiplexing gains, and high transmission directivity. A key component of a CSI may be a precoding matrix indicator (PMI), which indicates a WTRU-preferred precoder to be used by gNB in downlink codebook-based transmission.

5G NR may utilize various far-field (FF)-based codebooks for PMI reporting, mainly, Type I and Type II codebooks, Type II port selection, etc. For example, in Type I and Type II codebooks, the WTRU may be configured with a codebook of different FF beams, (e.g., Discrete Fourier Transform (DFT) beams). The WTRU may determine and reports a PMI comprising one or more of the configured FF beams. Thus, legacy FF-based CSI framework cannot support a WTRU located within the NF region with spot beams.

In an embodiment, considering that a WTRU is located in the Near Field (NF) of a TRP, as assumptions, the WTRU may know precoding coefficients used to construct different FF beams, more particularly, for a FF beam, the WTRU may identify the associated precoding coefficients with each antenna element/port to construct a FF beam. The WTRU may be aware of its presence in the NF region. Legacy CSI framework may consider FF propagation wherein the WTRU determines and reports a PMI comprising one or more FF beams.

Using legacy CSI framework in case of a WTRU is located within a NF region may lead to severe performance degradation, for instance, reduced array gain which in turn leads to reduced spectral efficiency, higher inter/intra-cell interference levels, especially to users within same spatial direction (this in turn leads to reduced spectral efficiency), and lower multiplexing gains and lower system capacity since only SDMA can be applied (LDMA cannot be applied)

A current problem can be formulated as: how to enhance FF-based CSI framework to enable NF beamfocusing (e.g., spot beams)?

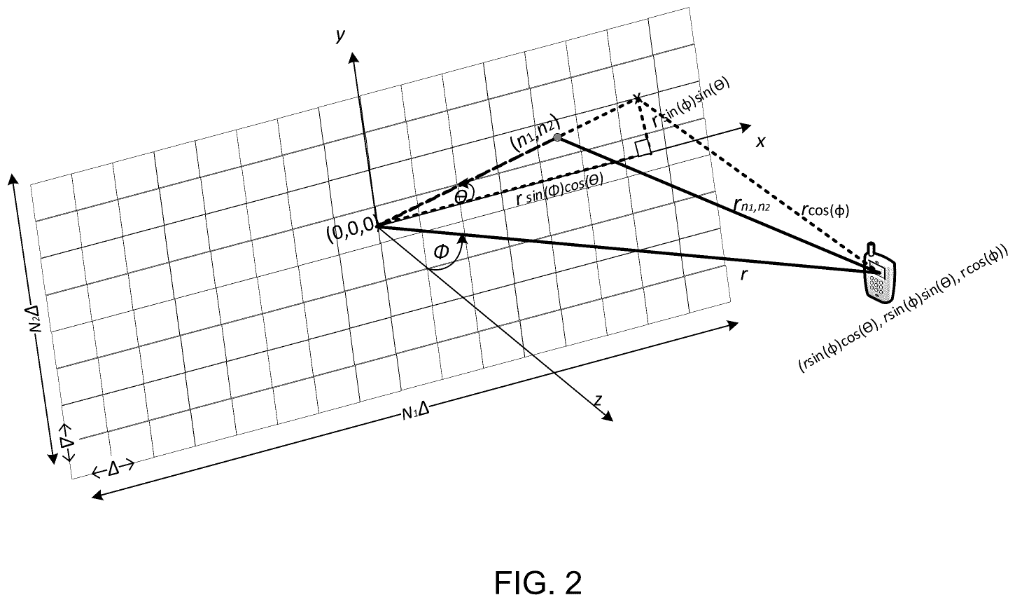

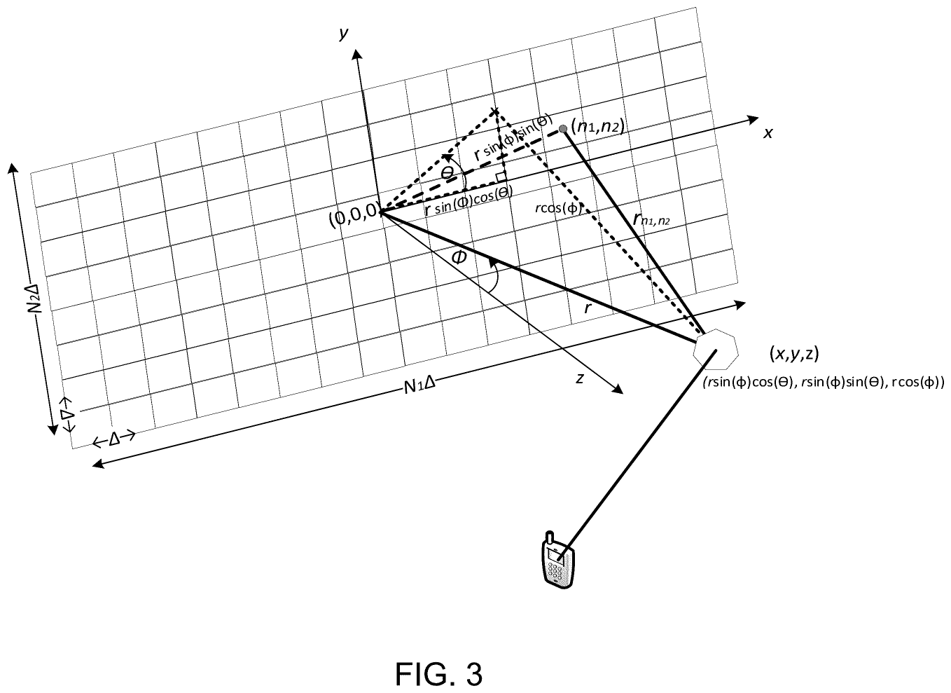

Referring to FIG. 2, in case of Line of Sight (LoS) transmission path between a WTRU and a TRP (e.g., gNB) and referring to FIG. 3 in case of non-Line of Sight (LoS) transmission path between a WTRU and a TRP (e.g., gNB), without loss of generality, assuming that a WTRU is equipped with a single antenna for reception and the gNB is equipped with a uniform planar array (UPA) of N₁×N₂ antenna elements, we may consider a single path between the gNB and the WTRU with uniform path gain. The NF beamfocusing beam v^{NF}∈ [symbol] for this transmission path may be represented as a function of the corresponding FF beam v^{FF}∈ [symbol] and a phase correction factor (b∈ [symbol] ). This factor may account for the non-linear phase relationship between different antenna elements when considering spherical waves instead of planar waves. Specifically, the NF beamfocusing beam v^{NF} may be expressed by

$${v}^{N {F}_{=}} {v}^{F F} ⊙ b . \qquad ( 1 )$$

Let bₙ_{₁}_{,n}_{₂} represents the n-th entry in the vector b, where n=N₁n₂+n₁. The term bₙ_{₁}_{,n}_{₂} corresponds to the phase correction factor to be applied for the antenna element (n₁, n₂). We assume that bₙ_{₁}_{,n}_{₂}=exp(jβₙ_{₁}_{, n}_{₂}), where βₙ_{₁}_{, n}_{₂} represents the phase term introduced to the antenna element (n₁, n₂) when considering spherical waves instead of planar waves. Therefore, the phase correction vector b may be expressed by

$$b = {[ \begin{matrix}{e}^{j {β}_{0 , 0}} & {e}^{j {β}_{1 , 0}} & {e}^{j {β}_{2 , 0}} & … & {e}^{j {β}_{{N}_{1} , {N}_{2}}}\end{matrix} ]}^{T} . \qquad ( 2 )$$

The phase term βₙ_{₁}_{, n}_{₂} may be determined using various expressions based on different approximation for calculating the distance ran, between the WTRU and the antenna elements (n₁, n₂). For example, using the first order Taylor series approximation to calculate the distance rₙ_{₁}_{,n}_{₂}, the phase term βₙ_{₁}_{, n}_{₂} may be computed as follows:

$${β}_{{n}_{1} , {n}_{2}} = \frac{{Δ}^{2}}{2 r} ( {n}_{1}^{2} + {n}_{2}^{2} ) , \qquad ( 3 )$$

where Δ may represent the spacing between different antenna elements in the UPA. The variable r denotes the distance between the WTRU and the center of the antenna array at the gNB in case of LoS transmission path between WTRU and gNB. However, in case of non-LoS transmission path, r refers to the distance between the scatterer and the center of the antenna array at the gNB. Using the second order Taylor series approximation for calculating the distance rₙ_{₁}_{,n}_{₂}, the term βₙ_{₁}_{, n}_{₂} can be computed as follows:

$${β}_{{n}_{1} , {n}_{2}} = \frac{{Δ}^{2}}{2 r} ( {n}_{1}^{2} + {n}_{2}^{2} - {sin}^{2} {ϕ ( {n}_{1} cos θ + {n}_{2} sin θ )}^{2} + \frac{Δ}{r} sin ϕ ( {n}_{1} cos θ + {n}_{2} sin θ ) ( {n}_{1}^{2} + {n}_{2}^{2} ) - \frac{{Δ}^{2}}{4 {r}^{2}} {( {n}_{1}^{2} + {n}_{2}^{2} )}^{2} ) , \qquad ( 4 )$$

where θ and φ denote the zenith/elevation and azimuth angles between the WTRU and the centre of antenna array at the gNB in case of LoS transmission path between the WTRU and gNB as shown in FIG. 2. However, in case of non-LoS path, θ and φ denote the zenith/elevation and azimuth angles between the scatterer and center of antenna array at the gNB as shown in FIG. 3.

Let c denotes a beamfocusing parameter. Larger beamfocusing parameter values may correspond to smaller beamfocusing distances, while smaller beamfocusing parameter values may correspond to larger beamfocusing distances. A particular value of c, (e.g., c=0), may correspond to infinite beamfocusing distance, and may correspond to a classical far field beam. In some cases, the beamfocusing parameter may also depend on other factors, such as antenna array geometry, e.g., antenna spacing, or one or more angles between the antenna array and the direction of the WTRU. In one example considered herein, let c≙Δ²/2r be defined as the beamfocusing parameter where Δ represents the antenna spacing. Consequently, βₙ_{₁}_{, n}_{₂} may be rewritten as shown in equations (5) and (6) considering the first and second order Taylor series approximations, respectively.

$${β}_{{n}_{1} , {n}_{2}} = c ( {n}_{1}^{2} + {n}_{2}^{2} ) , \qquad ( 5 )$$

$${β}_{{n}_{1} , {n}_{2}} = c ( {n}_{1}^{2} + {n}_{2}^{2} - {sin}^{2} {ϕ ( {n}_{1} cos θ + {n}_{2} sin θ )}^{2} + \frac{2 c}{Δ} sin ϕ ( {n}_{1} cos θ + {n}_{2} sin θ ) ( {n}_{1}^{2} + {n}_{2}^{2} ) - \frac{{c}^{2}}{{Δ}^{2}} {( {n}_{1}^{2} + {n}_{2}^{2} )}^{2} ) . \qquad ( 6 )$$

Based on the above, the WTRU may determine the required phase correction factor to construct a NF beam from a FF beam through determining a beamfocusing parameter c and angles θ, φ. Note that, the WTRU may determine the angles θ, φ directly from the selected FF beam.

The beamfocusing parameter c may take various forms. For instance, the beamfocusing parameter may be expressed as a function of one or more constants, which may be configurable, and a distance r, which the WTRU may determine, explicitly or implicitly. The distance r could represent, for example, the distance between the WTRU, e.g., a WTRU antenna, WTRU antenna array, or WTRU antenna panel, and a TRP, e.g., a reference point in a TRP antenna array such as the center, an edge or a corner, or the distance between a scatterer and a TRP. As an example, c may be expressed as a function of the distance r and a constant A, such that

$$c = f ( r , A ) . \qquad ( 7 )$$

In one example, the beamfocusing parameter c may be inversely proportional to the distance r such as c=A/r, or the beamfocusing parameter may be proportional to r, such as c=A*r.

In another example, the beamfocusing parameter can be represented as a function of the distance r, the wavelength λ, which may be configured to or determined by the WTRU, and one or more constants. For example, c can be expressed as a function of the distance r, the wavelength λ, and a constant A

$$c = f ( r , λ , A ) . \qquad ( 8 )$$

For brevity, we may consider the example that the beamfocusing parameter c is inversely proportional to r, specifically, c≙Δ²/2r. However, the following described embodiments may be applicable for any form of c, e.g., as in the examples above.

It can be noted that some embodiments herein are described such that increasing the distance r (e.g., as WTRU moves away from a TRP) may correspond to a decreasing of a beamfocusing parameter c, with may be in accordance with the considered example that c is inversely proportional to r. Similarly, decreasing the distance r (e.g., as WTRU moves towards a TRP) may correspond to increasing a beamfocusing parameter c, in the considered example. If a different form of c is used, (e.g., a form in which c is proportional to r), one or more solutions may be adjusted accordingly, so that increasing a distance r leads to increasing the value of beamfocusing parameter c and decreasing a distance r leads to decreasing the value of beamfocusing parameter c, etc.

A beamfocusing parameter may refer herein to a parameter value that a WTRU may apply to determine a required phase correction vector to be applied to a FF beam to construct a NF spot beam. It may be considered that a WTRU may construct a NF beam through selecting a FF beam and a beamfocusing parameter to be applied to this FF beam.

A beamfocusing parameter may correspond to any of a NF factor, a correction factor, a phase correction factor, a phase correction vector, or a phase correction precoder

A beamfocusing parameter may take on a value from a set of parameter values, e.g., a set of one or more discrete values, and/or one or more ranges of values. A set of beamfocusing parameters may herein refer to a set of parameter values for one or more beamfocusing parameter(s). The beamfocusing parameters in the set may be associated with parameter indices. For instance, the indices may be assigned to parameter values in the set, e.g., in an ascending (or descending) order based on the parameter value, wherein the smallest (or largest) parameter value may be associated with the lowest parameter index (e.g., 0 or 1).

A subset of beamfocusing parameters may include one or more beamfocusing parameters, e.g., from the set of beamfocusing parameters. A subset of beamfocusing parameters may be associated with a certain angular direction, region, distance range, etc.

It may be envisioned a subset of beamfocusing parameters as one or more beamfocusing parameters that are grouped together in one group.

A WTRU may determine, (e.g., be configured with), multiple subsets of beamfocusing parameters where each subset may be associated with a parameter subset index where the index may be global index or local index (e.g., local with a certain angle range, etc.)

Additionally, each included beamfocusing parameter within a subset of beamfocusing parameters may be associated with a parameter index, e.g., corresponding to the index of the beamfocusing parameter in the set of subsets of beamfocusing parameters, or an index local within the subset.

Different beamfocusing parameters within a subset may lead to constructing different spot beams.

A set of subsets of beamfocusing parameters may include one or more subsets of beamfocusing parameters. A set of subsets of beamfocusing, as well as the subset(s) therein, may be applicable to a context, for instance, one or more serving cell(s), one or more bandwidth part(s), e.g., of one or more serving cell(s), one or more carrier(s), one or more frequency band(s), one or more frequency range(s), one or more transmission and reception points (TRPs), one or more network node(s), etc., or any combination thereof. Different sets of subset may be applicable to different contexts.

A set of beamfocusing parameters may correspond to any of a codebook of beamfocusing parameters, a codebook of NF factors, a codebook of correction factors, a codebook of phase correction factors, or a codebook of phase correction precoders.

A codebook of correction factors may correspond to any of a codebook of phase correction precoders, a codebook of NF factors, a codebook of beamfocusing parameters, or a codebook of phase correction factors (e.g., phase correction vectors)

A codebook of correction factors may comprise one or more subsets of correction factors. Similarly, a codebook of beamfocusing parameters may comprise one or more subsets of beamfocusing parameters. Also, a codebook of NF factors may comprise one or more subsets of NF factors. A codebook of phase correction factors may comprise one or more subsets of phase correction factors.

A FF beam may correspond to a beam that focuses energy on a particular spatial direction. A FF beam may achieve the same beamforming gain, regardless of the distance between a transmitter and a receiver, as long as the far-field approximation is applicable.

A FF beam may correspond to a real- or complex-valued matrix, e.g., a vector for instance a precoding vector. Various examples with vectors used herein are non-limiting and equally applicable to matrices, since a matrix can be converted to a vector, e.g., by stacking columns or rows of the matrix into the vector, and a vector can be converted to a matrix by the reverse operation. For a vector corresponding to a FF beam, the phase may be linear, e.g., meaning that the phase progression throughout the vector is linear, wherein the phase corresponds to the phase of the complex numbers in the vector. A vector for which the phase is linear may, in short, be called a linear vector. A FF beam may also refer to a spatial domain basis vector (e.g., a spatial direction vector). A FF beam may refer to a FF basis beam. A linear vector used for precoding in a uniform linear array (ULA) may generate a FF beam. For other array geometries, other types of precoding vectors may generate a FF beam. An important example in practical systems is the uniform planar array (UPA). An UPA may be seen as an aggregation of multiple ULA, e.g., horizontal ULAs stacked vertically, or vertical ULAs stacked horizontally. Since a linear vector may generate a FF beam for a ULA, the aggregated linear vectors may generate a FF beam for the UPA comprising the corresponding aggregated ULAs. One way to describe a FF beam for a UPA is a matrix with dimensions corresponding to the number of horizontal and vertical antennas. Another, and equivalent, way to describe a FF beam for a UPA is a vector with a length corresponding to the number of horizontal and vertical antennas. In an example, the first part of the vector may correspond to the first horizontal row of antennas, the subsequent part of the vector may correspond to the second horizontal row of antennas, etc. In another example, the first part of the vector may correspond to the first vertical column of antennas, the subsequent part of the vector may correspond to the second vertical column of antennas, etc. A vector for a UPA may be described as a Kronecker product between two vectors (both either column vectors or row vectors). A vector corresponding to a FF beam for a UPA may be described as a Kronecker product between two linear vectors, wherein a first of the two vectors may correspond to a FF beam in a first, e.g., the horizontal, dimension and a second of the two vectors may correspond to a FF beam in a second, e.g., the vertical, dimension. Such a vector may be denoted a Kronecker vector herein. A Kronecker vector constructed from two linear vectors may be piece-wise linear, e.g., the Kronecker vector is linear in the first N elements, the second N elements, etc., wherein N is the length of one of the two linear vectors. The phase of the last of the first N elements and the phase of the first of the second N elements might not follow the linearity, etc., which is why the Kronecker vector may be described as piece-wise linear. A Kronecker vector may be piece-wise linear also if only one of the two vectors is linear, while the other is non-linear. Such a Kronecker vector may be useful if a WTRU is in the FF based on the array aperture of a first dimension, e.g., horizontal or vertical, but in the NF based on the array aperture of a second dimension, e.g., vertical or horizontal. The corresponding Kronecker vector may correspond to a FF beam in a first dimension and a NF beam in a second dimension. Non-linear vectors may be also considered. In various embodiments, a piece-wise linear vector, e.g., a Kronecker vector, may be classified as non-linear, e.g., if it is constructed from a linear vector and a non-linear vector (that is not a Kronecker vector). In various embodiments, a piece-wise linear vector, e.g., a Kronecker vector, may be classified as not being non-linear, e.g., if it is constructed from two linear vectors. In one example, a first vector is a Kronecker product, e.g., a Kronecker vector, of a second vector and a single-element vector, which could alternatively be viewed as a scalar. The first vector would be linear if the second vector is linear, since the first vector would be equal to the second vector times the element of the single-element vector.

A codebook of FF beams, or just a codebook, may refer to a codebook that includes different FF beams. Different FF beams that can focus the energy in different spatial directions, i.e., different FF beams focuses energy in different spatial directions.

Also, a codebook of FF beams may refer to a set of FF beams. A FF beam may correspond to a vector from a codebook of FF beams. A FF beam may correspond to a codeword from a codebook of FF beams. A codebook of FF beams may refer to a codebook of FF precoders. A FF beam may correspond to a FF precoder (e.g., rank-1 FF precoder in a codebook of FF precoders)

Selecting a FF beam may correspond to selecting any of a FF precoder, a codeword in a configured codebook, (e.g., codebook of FF beams, codebook of FF precoders), or a vector in a configured codebook, (e.g., codebook of FF beams, codebook of FF precoders).

A codebook of FF beams may refer to a two-dimensional grid of FF beams where each FF beam may be associated with a beam index. Also, each FF beam may be associated with two indices where the first index may indicate a horizontal beam index and the second index may indicate a vertical beam index.

An example of a FF is DFT beam. Also, a codebook of FF beams may refer to a codebook of DFT beams where a codebook of DFT beams may include one or more orthogonal DFT beams and one or more oversampled DFT beams. One or more orthogonal DFT beams may correspond to columns in a DFT matrix.

A subset of FF beams may refer to one or more FF beams that are grouped together. A subset of FF beams may be associated with a certain angle range. A WTRU may be configured with multiple subsets of FF beams where each subset is associated with a beam subset index. Additionally, each included FF beam within a subset of FF beams may be associated with one or more beam indices.

The term subset of FF beams can be used to indicate any of an angular direction (angle range), or one or more FF beams that are grouped together

‘Phase calculation function’ term may represent the function that is used to calculate the phase correction term. A WTRU may be configured with a function based on a first Taylor series expansion or a second Taylor series expansion

Beamfocusing parameter search space may refer to one or more candidate beamfocusing parameters to construct a NF spot beam. A search space may refer to any of a subset of beamfocusing parameters, a set of beamfocusing parameters, one or more beamfocusing parameters from a subset of beamfocusing parameters, or one or more beamfocusing parameters from a set of beamfocusing parameters

Angle/Angle range may refer to an angle between a WTRU and a TRP, e.g., angle between the WTRU and a UPA in the TRP. In addition, it may refer to an angle, e.g., of a transmitted FF beam, from the TRP wherein each FF beam may correspond to a specific angle.

The angle may be measured with respect to a TRP reference direction based on orientation of the TRP's antenna array, e.g., UPA. For instance, angle may be measured with respect to the bore sight of the UPA in a TRP. Angle may represent a zenith/elevation angle an azimuth angle or both, e.g., a combination thereof. Angle range may refer to a range of angles which can be described, e.g., by a minimum angle and a maximum angle.

Range index may correspond to a distance range index or an angle range index. For example, if range index is used to indicate a distance range, it refers to a distance range index. Differently, if range index is used to indicate an angle range, it refers to an angle range index. Similarly, a range may correspond to a distance range or an angle range.

Distance/Distance range may refer to a distance between a WTRU and a TRP or a distance between a TRP and a scatterer. Distance range may refers to a range of distances which can be described, e.g., by a minimum distance and a maximum distance.

In the following embodiments, a WTRU may be “configured with” may refer to the scenario that the WTRU may receive a configuration (e.g., static, dynamic, semi-persistent) from a TRP (e.g., gNB) or another node, e.g., using RRC signaling. The WTRU may be ‘configured’ or ‘(pre)-configured’ to perform an action may also refer to the scenario that the WTRU is hard coded to perform the action via standard specifications.

About WTRU configuration of subset of FF beams, a WTRU may be configured with a codebook of FF beams, e.g., a codebook including one or more FF beams where each FF beam is associated with a beam index. In addition, a WTRU may be configured with one or more subsets of FF beams where each subset of FF beams includes one or more FF beams. Also, each subset of FF beams may be associated with a beam subset index. The WTRU may map FF beams to the corresponding subset of FF beams based on one or any combination of the following.

A WTRU may be configured with one or more subsets of FF beams where each subset is associated with a beam subset index. Also, a WTRU may be configured with a number of FF beams for each subset of FF beams.

As a first example, a WTRU may be configured with equal number of FF beams within each subset of FF beams (WTRU uniformly divides the configured codebook of FF beams among configured subsets of FF beams). For example, if the WTRU is configured with 4 FF beams within each subset of FF beams, the first subset of FF beams may include FF beams with beam indices from 0 to 3 where the second subset of FF beams may include FF beams with beam indices from 4 to 7 and so on.

As a second example, a WTRU may be configured with different number of FF beams for different subsets of FF beams. A WTRU may be configured with index of first FF beam within the first subset of FF beams. The WTRU may map different configured FF beams to different subsets based on the configured number of FF beams for each subset and the beam index of first FF beam in each subset. The WTRU may determine the first FF beam index for a subset of FF beams based on the first FF beams index in the previous subset of FF beams and the number of FF beams configured for the previous subset of FF beams.

In an embodiment, a WTRU may be configured with number of (e.g., adjacent) horizontal beams and number of (e.g., adjacent) vertical beams within each subset of FF beams.

As a first example, a WTRU may be configured with number of (e.g., adjacent) horizontal FF beams and number of (e.g., adjacent) vertical FF beams within each subset of FF beams. The WTRU may (e.g., uniformly) divide the configured codebook of FF beams among configured subsets of FF beams. For example, if the WTRU is configured with two (e.g., adjacent) horizontal FF beams and four (e.g., adjacent) vertical FF beams within each subset of FF beams, the first subset of FF beams may include eight FF beams with the following horizontal and vertical beams indices {(0,0), (1,0), (0,1), (1,1), (0,2), (1,2), (0,3), (1,3)}. The second subset of FF beams may include eight FF beams with the following horizontal and vertical beams indices {(2,0), (3,0), (2,1), (3,1), (2,2), (3,2), (2,3), (3,3)}, and so on.

As a second example, the WTRU may be configured with different number of (e.g., adjacent) horizontal FF beams and/or different number of (e.g., adjacent) vertical FF beams for different subsets of FF beams. Also, the WTRU may be configured with horizontal FF beam index and vertical FF beam index of the first beam in a subset of FF beams. The WTRU may map different configured FF beams in the codebook of FF beams to a subset of FF beams based on the configured number of horizontal and vertical FF beams and the horizontal and vertical beam indices of a first beam in this subset of FF beams.

A WTRU may be configured with one or more subsets of FF beams where each subset may be associated with a beam subset index. Also, a WTRU may be configured with association between subsets of FF beams and configured FF beams (FF beams in the configured codebook of FF beams).

As an example, each subset of FF beams may be associated with one or more beam indices indicating the beam indices of FF beams associated with this subset of FF beams.

As another example, each subset of FF beams may be associated with two beam indices where first and second beam indices may indicate the first and last FF beams within this subset of FF beams, respectively.

As another example, each subset of FF beams may be associated with one or more beam indices indicating the horizontal and vertical beam indices of FF beams associated with this subset of FF beams.

As another example, each subset of FF beams may be associated with two sets of beam indices where the first set of beam indices may include two beam indices where first and second beam indices may indicate the minimum and maximum horizontal beams indices associated with the subset of FF beams, respectively. Additionally, the second set of beam indices may include two beam indices where first and second beam indices may indicate the minimum and maximum vertical beams indices associated with the subset of FF beams, respectively.

As an example, each subset of FF beams may be associated with two set of beam indices where the first set of beam indices may include two beam indices indicating the horizontal and vertical beam indices of the first FF beam in the subset of FF beams. The second set of beam indices may include two beam indices indicating the horizontal and vertical beam indices of the last FF beam in the subset of FF beams.

A WTRU may be configured with one or more subsets of FF beams where each subset is associated with a beam subset index. Also, a WTRU may be configured with different angle ranges and association(s) between subsets of FF beams and configured angle ranges.

As a first example, the WTRU may be configured with a number of quantization levels of angular domain. Also, the WTRU may be configured with association between subsets of FF beams and quantized angle ranges, e.g., (i) each subset of FF beams may be associated with one or more range indices indicating one or more angle ranges associated with this subset of FF beams; (ii) each subset of FF beams may be associated with two range indices where the first and second range indices indicating the first and last angle ranges associated with this subset of FF beams;

Then, the WTRU may map FF beams to the corresponding subset of FF beams based on the configured association between subsets of FF beams and angle ranges. For instance, for a subset of FF beams associated with a first angle range, this subset may include all FF beams with angular direction within the first angle range and so on.

As a second example, the WTRU may be configured with multiple quantization levels, for instance, the WTRU may be configured with a primary number of quantization levels based on which it quantizes the whole angular domain. Then, the WTRU may be configured with further quantization for one or more of the primarily quantized angular ranges (e.g., two levels of quantization). A subset of FF beams may be associated with: (i) an angular range that is quantized based on the primary number of quantization levels, (ii) an angular range resulted from further quantization of one of the primarily quantized angular ranges.

Then, the WTRU may map FF beams to the corresponding subset of FF beams based on the configured association between subsets of FF beams and angle ranges.

A WTRU may be configured with different configurations of sets of subsets of beams. The WTRU may receive activation/deactivation for a configuration of a set of subsets of FF beams. The WTRU may receive activation/deactivation of a configuration for a set of subsets of FF beams in a medium access control (MAC) control element (CE) or in a downlink control information (DCI). A MAC CE may be carried in a Physical Downlink Shared Channel (PDSCH). A DCI may be carried in a Physical Downlink Control Channel (PDCCH).

A bitmap carried by the MAC CE may be applied by a gNB (e.g., TRP) to indicate to the WTRU which set of subsets of the FF beams should be activated or deactivated. The bitmap may contain multiple bits. Each bit may be associated with a set of subsets of FF beams. The association between each bit of the bitmap and each set of subsets of FF beams may be, but not limited to, determined based on any of: identity of the set of subsets of FF beams; value of the identity of the set of subsets of FF beams; and order of the bit within the bitmap.

For example, the first bit within the bitmap may be applied to indicate WTRU whether the set of subsets of FF beams having smallest identifier value, e.g., index, should be activated or deactivated. The second bit within the bitmap may be applied to indicate WTRU whether the set of subsets of FF beams having second smallest identifier value should be activated or deactivated, and so on.

In another example, the MAC CE may carry at least an activation/deactivation indicator and an identifier of a set of subsets of FF beams. The activation/deactivation indicator may indicate whether the set of subsets of FF beams identified by the identifier of the configuration of the subset of FF beams should be activated or deactivated.

A specific field in a DCI may be applied by the gNB (e.g., TRP) to indicate WTRU which sets of subsets of FF beams should be activated or deactivated. The specific field may contain multiple bits. Each bit may be associated with a set of subsets of FF beams. The association between each bit of the bitmap and each subset of FF beams may be, but not limited to, determined based on any of: identity of the set of subsets of FF beams; value of the identity of the subset of FF beams; and order of the bit within the field;

For example, the first bit within the field may be applied to indicate WTRU whether the set of subsets of FF beams having smallest identifier value should be activated or deactivated. The second bit within the field may be applied to indicate WTRU whether the set of subsets of FF beams having second smallest identifier value should be activated or deactivated, and so on.

A WTRU may also receive an activation/deactivation of a subset of FF beams that may correspond to a codebook subset restriction configuration. The codebook may correspond to the set of FF beams and the codebook subset restriction may restrict the WTRU selection of some FF beams in the set of FF beams. A codebook subset restriction might not restrict the selection of FF beams in some subsets of FF beams. A codebook subset restriction may restrict the selection of one or more, but not all, FF beams in some subsets of FF beams. A codebook subset restriction may restrict the selection of all FF beams in some subsets of FF beams, which may be considered to be deactivated by the codebook subset restriction.

The WTRU may receive activation/deactivation of a subset of FF beams in a medium access control (MAC) control element (CE) or in a downlink control information (DCI). A MAC CE may be carried in a PDSCH. A DCI may be carried in a PDCCH.

A bitmap carried by the MAC CE may be applied by the gNB (eg. TRP) to indicate WTRU which subset of the FF beams should be activated or deactivated. The bitmap may contain multiple bits. Each bit may be associated with a subset of FF beams. The association between each bit of the bitmap and each subset of FF beams may be, but not limited to, determined based on any of: identity of the subset of FF beam; value of the identity of the subset of FF beams; and order of the bit within the bitmap.

For example, the first bit within the bitmap may be applied to indicate WTRU whether the subset of FF beams having smallest identifier value, e.g., index, should be activated or deactivated. The second bit within the bitmap may be applied to indicate WTRU whether the subset of FF beams having second smallest identifier value should be activated or deactivated, and so on.

In another example, the MAC CE may carry at least an activation/deactivation indicator and an identifier of a subset of FF beams. The activation/deactivation indicator indicates whether the subset of FF beams identified by the identifier of the configuration of the subset of FF beams should be activated or deactivated.

A specific field in a DCI may be applied by the gNB (e.g., TRP) to indicate WTRU which subsets of FF beams should be activated or deactivated. The specific field may contain multiple bits. Each bit is associated with a subset of FF beams. The association between each bit of the bitmap and each subset of FF beams may be, but not limited to, determined based on any of: identity of the subset of FF beams; value of the identity of the subset of FF beams; and order of the bit within the field.

For example, the first bit within the field may be applied to indicate WTRU whether the subset of FF beams having smallest identifier value should be activated or deactivated. The second bit within the field may be applied to indicate WTRU whether the subset of FF beams having second smallest identifier value should be activated or deactivated, and so on.

In an embodiment, a WTRU may be configured with a DFT codebook which contains N (e.g., 2D) DFT beams (e.g., spatial direction vectors (SD vectors)). The WTRU may determine the number of beams N in the DFT codebook as a function of the number of horizontal antenna ports (N₁) in a UPA at a TRP, the number of vertical antenna ports (N₂) in a UPA at a TRP, the oversampling factor in horizontal direction (O₁), the oversampling factor in vertical direction (O₂), and the antenna polarization. For instance, N=2 (N₁O₁)(N₂O₂) for cross polarization UPA and N=(N₁O₁)(N₂O₂) for single polarization UPA.

The different DFT beams in a codebook of DFT beams may be grouped in one group, e.g., a subset of FF beams, a subset of DFT beams. Assuming that each subset of DFT beams include X DFT beams, the total number of subsets of DFT beams will be

$${M}_{s} = ⌈ \frac{N}{X} ⌉ .$$

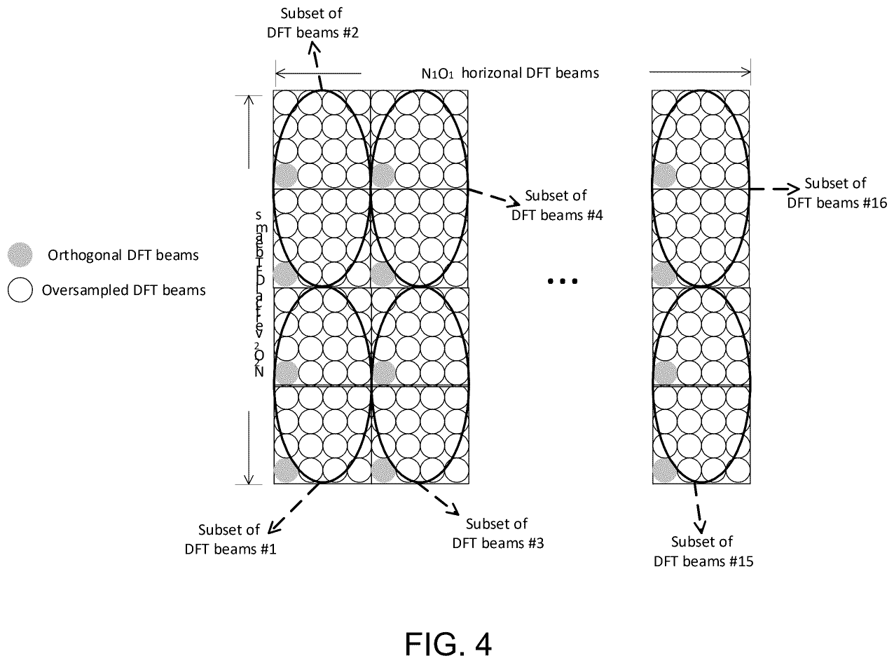

As an example, referring to FIG. 4, a codebook of DFT beams with horizontal antenna ports N₁=8 and vertical antenna ports N₂=4, are shown. The oversampling for horizontal and vertical directions may be set to 4, i.e., O₁=O₂=4. Therefore, the (2D) DFT codebook size may be equal to (N₁O₁)(N₂O₂)=512 for a UPA with single polarization. In the other words, there are 512 DFT beams. In this case, X=32 DFT beams are grouped in each subset of DFT beams. Thus, there are

$${M}_{s} = \frac{512}{32} = 16$$

subsets of DFT beams.

About WTRU configuration of beamfocusing parameters, in an embodiment, a WTRU may be configured with one or more subsets of beamfocusing parameters where each subset includes one or more beamfocusing parameters. Also, each subset of beamfocusing parameters may be associated with a parameter subset index. The WTRU may be configured with association between configured or otherwise determined subsets of beamfocusing parameters and different angular directions from the NW.

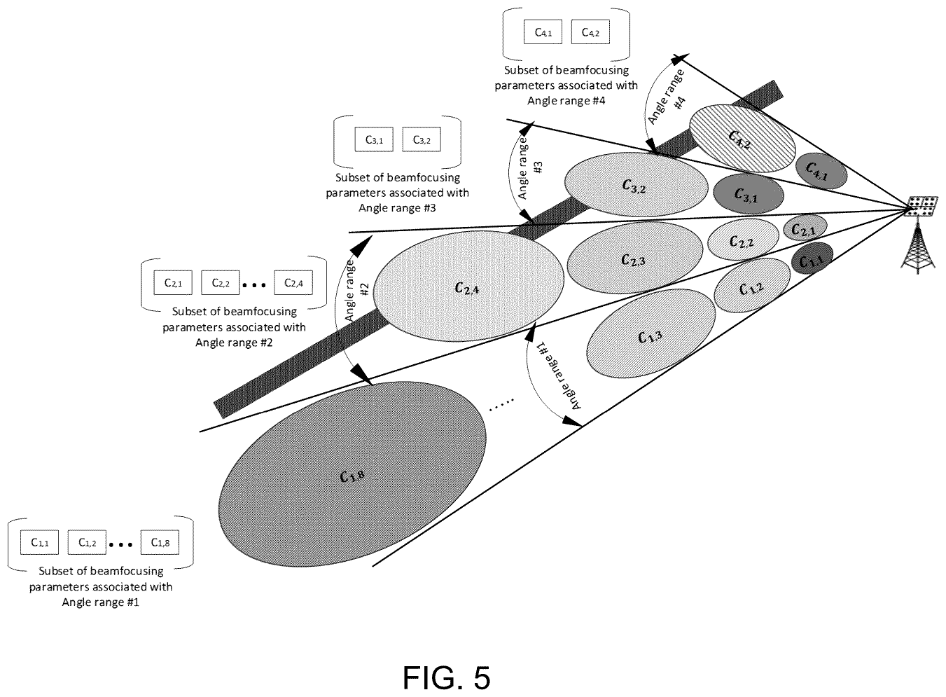

Referring to FIG. 5, different directions from a BS (e.g., TRP) may be associated with different path lengths (line-of-sight (LoS) & non-LoS (NloS)) which corresponds to different subsets of beamfocusing parameters. Such approach may facilitate the WTRU searching for a beamfocusing parameter for constructing a NF beam as WTRU may need to search for the beamfocusing parameter is a subset associated with the FF beam used to construct the NF beam.

About configurations of association between subsets of beamfocusing parameters and subsets of FF beams (which represent different angular directions), a WTRU may be configured with association between configured, or otherwise determined, subsets of beamfocusing parameters and configured subsets of FF beams.

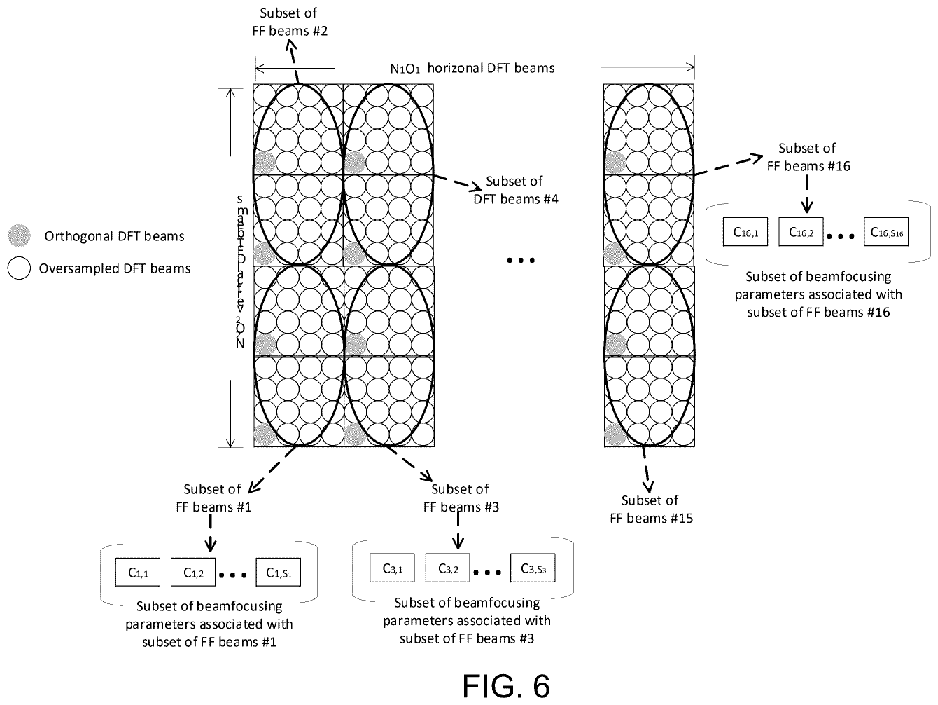

As a first example, a WTRU may be configured with one-to-one mapping between subsets of FF beams and subsets of beamfocusing parameters as shown in FIG. 5 and FIG. 6. For example, (i) for each subset of FF beams, the WTRU may be configured with a parameter subset index indicating associated subset of beamfocusing parameters with the subset of FF beams; (ii) alternatively, for a configured, or otherwise determined, subset of beamfocusing parameters, WTRU may be configured with a beam subset index indicating associated subset of FF beams with the subset of beamfocusing parameters.

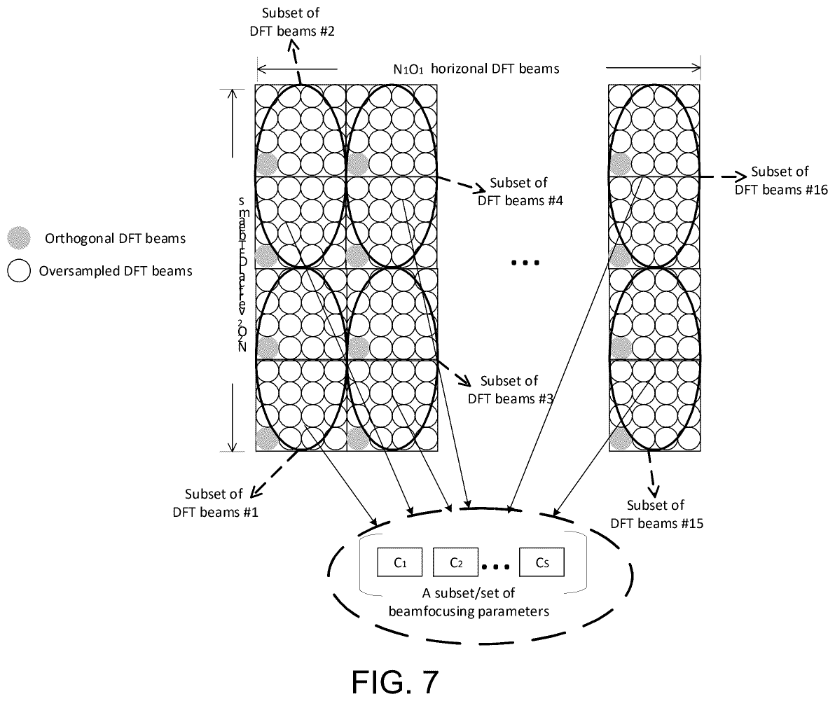

As a second example, a WTRU may be configured with many-to-one mapping between subsets of FF beams and subsets of beamfocusing parameters. Referring to FIG. 7, in an embodiment, multiple subsets of FF beams may be associated with same subset of beamfocusing parameters. For example, (i) for a configured, or otherwise determined, subset of beamfocusing parameters, WTRU may be configured with one or more beam subset indices indicating associated subsets of FF beams with the subset of beamfocusing parameters; (ii) for a configured, or otherwise determined, subset of beamfocusing parameters, WTRU may be configured with two beam subset indices indicating multiple subsets of FF beams where the first and second beam subset indices may indicate the first and last subsets of FF beams associated with the subset of beamfocusing parameters, respectively.

As a third example, a WTRU may be configured with one-to-many mapping between subsets of FF beams and subsets of beamfocusing parameters (one subset of FF beams may be associated with multiple subsets of beamfocusing parameters). For example, (i) for a configured subset of FF beams, the WTRU may be configured with one or more parameter subset indices indicating associated subsets of beamfocusing parameters with the subset of FF beams; (ii) for a configured subset of FF beams, the WTRU may be configured with two parameter subset indices indicating multiple subsets of beamfocusing parameters where the first and second parameter subset indices may indicate the first and last subsets of beamfocusing parameters associated with the subset of FF beams, respectively.

As a fourth example, a WTRU may be configured with many-to-many mapping between subsets of FF beams and subsets of beamfocusing parameters (multiple subsets of FF beams are associated with multiple subsets of beamfocusing parameters). For example, (i) for a configured, or otherwise determined, subset of beamfocusing parameters, WTRU may be configured with one or more beam subset indices indicating associated subsets of FF beams with the subset of beamfocusing parameters; (ii) for a configured, or otherwise determined, subset of beamfocusing parameters, WTRU may be configured with two beam subset indices indicating multiple subsets of FF beams where the first and second beam subset indices may indicate the first and last subsets of FF beams associated with the subset of beamfocusing parameters, respectively; (iii) for a configured subset of FF beams, WTRU may be configured with one or more parameter subset indices indicating associated subsets of beamfocusing parameters with the subset of FF beams; (iv) for a configured subset of FF beams, WTRU may be configured with two parameter subset indices indicating multiple subsets of beamfocusing parameters where the first and second parameter subset indices may indicate the first and last subsets of beamfocusing parameters associated with the subset of FF beams, respectively.

Referring to FIG. 7, an example of many-to-one mapping between subsets of FF beams and subsets of beamfocusing parameters is the case where all FF beams are associated with the same set/subset of beamfocusing parameters.

About configurations of multiple subsets of beamfocusing parameters for the same subset of FF beams, In an embodiment, a subset of FF beams may be associated with multiple subsets of beamfocusing parameters. For example, a WTRU may be configured with, or otherwise determined, one or any combination of the following examples.

As a first example, the WTRU may be configured with, or otherwise determined, an extended subset including large number of beamfocusing parameters, (e.g., generated with high resolution, corresponding to one or more possible LoS spot beams within the angular direction for the subset of FF beams, etc.) and a reduced subset of beamfocusing parameters including small number of beamfocusing parameters, (e.g., generated with low resolution, corresponding to focus beams at one or more scatterers within the angular direction for the subset of FF beams).

As a second example, the WTRU may be configured with, or otherwise determined, different subsets of beamfocusing parameters for different distance ranges. For instance, the WTRU may be configured with different distance ranges associated with a subset of FF beams. The WTRU may be configured with association between the configured, or otherwise determined, subsets of beamfocusing parameters and the different distance ranges. For a subset of FF beams, the WTRU may be configured with a maximum and a minimum distances and number of quantization levels (number of bits) for distance sampling. For a configured, or otherwise determined, subset of beamfocusing parameters for this subset of FF beams, the WTRU may be configured with a bitmap indicating associated distance range with this subset of beamfocusing parameters.

As a third example, the WTRU may be configured with association between different subsets of beamfocusing parameters and different phase calculation function. For instance, the WTRU may be configured with, or otherwise determined, a first subset of beamfocusing parameters associated with a phase calculation function based on first order Taylor series approximation. Also, the WTRU may be configured with, or otherwise determined, a second subset of beamfocusing parameters associated with a phase calculation function based on second order Taylor series approximation.

About configurations of region-based subsets of beamfocusing parameters, in an embodiment, a WTRU may be configured with, or otherwise determined, one or more subsets of beamfocusing parameters where each subset includes one or more beamfocusing parameters. Also, each subset of beamfocusing parameters may be associated with a parameter subset index. The WTRU may be configured with association between configured, or otherwise determined, subsets of beamfocusing parameters and different regions in the cell.

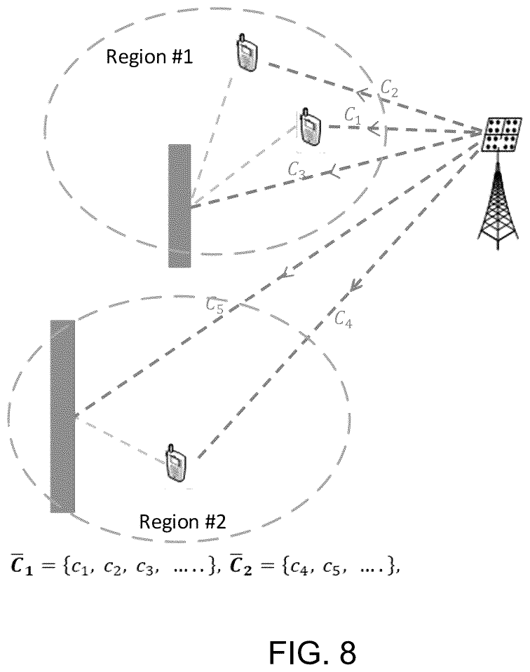

Referring to FIG. 8, different parts of the cell may have different path lengths (LoS & NLoS) which corresponds to different subsets of beamfocusing parameters. Such approach may facilitate the WTRU searching for a beamfocusing parameter for constructing a NF beam as WTRU needs to search for the beamfocusing parameter is a subset associated with the region in which the WTRU exists.

In an embodiment, a WTRU may be configured with different regions (e.g., zones) where each region is associated with region ID/index. For instance, different regions may be associated with a distance range, e.g., the WTRU may be configured with a maximum and/or minimum distance defining a distance range. For instance, the WTRU may be configured with minimum and maximum distances and number of quantization levels for distance sampling. The WTRU may receive a bitmap indicating a certain distance range where the WTRU may identify the distance range associated with a region based on the received bitmap and the distance sampling configurations.

For instance, different regions may be associated with angle range, e.g., a WTRU may be configured with a maximum and/or minimum angle defining an angle range. For instance, the WTRU may be configured with minimum and maximum angles and number of quantization levels for sampling of angular domain. The WTRU may receive a bitmap indicating a certain angle range where the WTRU may identify the angle range associated with a region based on the received bitmap and the angular domain sampling configurations

For instance, different regions may be associated with a combination of angle range and distance range.

A WTRU may be configured with different configurations for construction of different regions. In particular, the different configurations may lead to the definition of different regions (e.g., the angles and/or distance ranges for different regions). The WTRU may receive activation/deactivation of a region configurations. The WTRU may receive activation/deactivation of a configuration for different regions in a medium access control (MAC) control element (CE) or in a downlink control information (DCI). A MAC CE may be carried in a PDSCH. A DCI may be carried in a PDCCH.

A WTRU may be configured with association between configured regions and configured, or otherwise determined, subsets of beamfocusing parameters.

Referring to FIG. 8, a WTRU may be configured with one-to-one mapping between configured regions and subsets of beamfocusing parameters. For example, for a configured subset of beamfocusing parameters, the WTRU may be configured with a region index indicating associated region with it. Alternatively, for example, for a configured region, the WTRU may be configured with a parameter subset index indicating associated subset of beamfocusing parameters with it.

A WTRU may be configured with one-to-many mapping between configured regions and subsets of beamfocusing parameters. For example, for a configured region, the WTRU may be configured with one or more parameter subset indices indicating subsets of beamfocusing parameters associated with it. For example, for a configured region, the WTRU may be configured with two parameter subset indices indicating multiple subsets of beamfocusing parameters associated with it where the first and second parameter subset indices may indicate the first and last subsets of beamfocusing parameters associated with this region, respectively.

About configurations of multiple subsets of beamfocusing parameters for a configured region, In a solution, a configured region may be associated with multiple subsets of beamfocusing parameters. For example, a WTRU may be configured with one or any combination of the following examples.

As a first example, the WTRU may be configured with, or otherwise determined, extended subset including large number of beamfocusing parameters, (e.g., generated with high resolution, corresponding to one or more possible LoS spot beams within the configured region, etc.) and a reduced subset of beamfocusing parameters including small number of beamfocusing parameters, (e.g., generated with low resolution, corresponding to focus beams at one or more scatterers within the configured region).

As a second example, the WTRU may be configured with association between different subsets of beamfocusing parameters and different phase calculation function. For instance, the WTRU may be configured to associate a first subset of beamfocusing parameters with a first phase calculation function, e.g., based on first order Taylor series approximation. Also, the WTRU may be configured to associate a second subset of beamfocusing parameters with a second phase calculation function, e.g., based on second order Taylor series approximation.

About configurations of parameters for constructing subsets of beamfocusing parameters, a WTRU may be configured with one or more parameters for constructing one or more subsets of beamfocusing parameters. In an embodiment solution, the WTRU may be configured with one or more of: (i) one or more parameters indicating one or more possible minimum beamfocusing parameters; (ii) one or more parameters indicating one or more possible maximum beamfocusing parameters; (iii) one or more parameters (e.g., integer values) indicating one or more possible quantization levels of beamfocusing parameters; and (iv) one or more parameters (e.g., integer values) indicating one or more possible number of bits for beamfocusing parameters quantization.

A WTRU may be configured with association between configured parameters for constructing subsets of beamfocusing parameters and configured subsets of FF beams or configured regions. For example, a WTRU may be configured with one or any combination of the following examples.

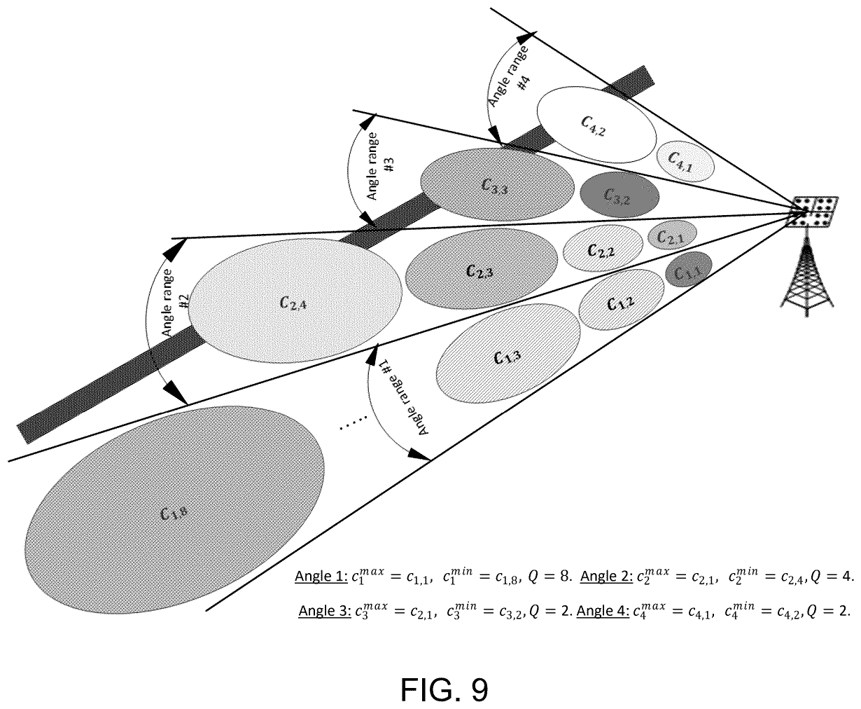

As a first example, referring to FIG. 9, the WTRU may be configured with one-to-one mapping between configured subsets of FF beams or configured regions and configured parameters for constructing subsets of beamfocusing parameters. For example, for a configured subset of FF beams, WTRU may be configured with a parameter index indicating a minimum beamfocusing parameter associated with it. For example, for a configured subset of FF beams, WTRU may be configured with a parameter index indicating a maximum beamfocusing parameter associated with it. For example, for a configured subset of FF beams, the WTRU may be configured with a quantization level index indicating a number of beamfocusing parameter quantization levels associated with it. For example, for a configured subset of FF beams, the WTRU may be configured with an index indicating a number of bits for beamfocusing parameter quantization associated with it. For example, for a configured region, the WTRU may be configured with a parameter index indicating a minimum beamfocusing parameter associated with it. For example, for a configured region, the WTRU may be configured with a parameter index indicating a maximum beamfocusing parameter associated with it. For example, for a configured region, the WTRU may be configured with a quantization level index indicating a number of beamfocusing parameter quantization levels associated with it. For example, for a configured region, the WTRU may be configured with an index indicating a number of bits for beamfocusing parameter quantization associated with it.

As a second example, a WTRU may be configured with many-to-one mapping between configured subsets of FF beams or configured regions and configured parameters for constructing subsets of beamfocusing parameters.

For example, the WTRU may be configured with association between one or more beam subset indices of configured subsets of FF beams and a parameter index indicating a minimum beamfocusing parameter associated with these subset(s) of FF beams.

For example, the WTRU may be configured with association between one or more beam subset indices of configured subsets of FF beams and a parameter index indicating a maximum beamfocusing parameter associated with these subset(s) of FF beams.

For example, the WTRU may be configured with association between one or more beam subset indices of configured subsets of FF beams and a quantization level index indicating a number of beamfocusing parameter quantization levels associated with these subset(s) of FF beams.

For example, the WTRU may be configured with association between one or more beam subset indices of configured subsets of FF beams and an index indicating a number of bits for beamfocusing parameter quantization associated with these subset(s) of FF beams.

For example, the WTRU may be configured with association between one or more region indices of configured regions and a parameter index indicating a minimum beamfocusing parameter associated with these regions.

For example, the WTRU may be configured with association between one or more region indices of configured regions and a parameter index indicating a maximum beamfocusing parameter associated with these regions.

For example, the WTRU may be configured with association between one or more region indices of configured regions and a quantization level index indicating a number of beamfocusing parameter quantization levels associated with these regions.

For example, the WTRU may be configured with association between one or more region indices of configured regions and an index indicating a number of bits for beamfocusing parameter quantization associated with these regions.

About WTRU determination of Subsets of beamfocusing parameters, a WTRU may determine/construct a subset of beamfocusing parameters. The WTRU may determine/construct a subset of beamfocusing parameters based on preconfigured parameters such as minimum beamfocusing parameter, maximum beamfocusing parameter, beamfocusing parameters quantization levels, rough estimation of the distance, etc.

For example, the WTRU may determine/construct a subset of beamfocusing parameters for a certain angle (subset of FF beams) using the minimum configured beamfocusing parameter, the maximum configured beamfocusing parameter and a configured quantization level.

For example, the WTRU may determine/construct a subset of beamfocusing parameters for a certain angle (subset of FF beams) using the minimum configured beamfocusing parameter, rough estimation of the distance, and a configured quantization level.

For example, the WTRU may select the quantization level for determining/constructing the beamfocusing parameter subset based on the rough estimated distance.

The WTRU may determine, (e.g., construct), a set of subsets of beamfocusing parameters. The WTRU may base the determination on one or more parameters, which may have been indicated or configured to the WTRU by the network (e.g. gNB), or pre-configured to the WTRU. The WTRU may base the determination on one or more measurements results determined by the WTRU.

The WTRU may determine multiple sets of subsets of beamfocusing parameters, e.g., for different contexts or for the same context. However, the determination of a set of subsets of beamfocusing parameters is described herein. Different sets of subsets of beamfocusing parameters may be determined using the same or different methods. The subsets of beamfocusing parameters may comprise values from a set of beamfocusing parameters, which may be configured to the WTRU, e.g., for the applicable context, or pre-configured.

In an embodiment, a WTRU may determine a set of subsets of beamfocusing parameters based on received configuration(s). For example, an explicit configuration may comprise a list of subset configurations. A subset configuration, e.g., in the list, may comprise a list of beamfocusing parameters. The list of beamfocusing parameters may comprise a list of parameter indices in the set of beamfocusing parameters.

In an embodiment, a WTRU may determine a set of subsets of beamfocusing parameters based on one or more configured subset properties. For example, subset properties may comprise any of one or more minimum beamfocusing parameter(s), one or more maximum beamfocusing parameter(s), and one or more quantization level(s).

In an example, a subset of beamfocusing parameters may be determined based on a minimum beamfocusing parameter and a maximum beamfocusing parameter. The WTRU may determine the subset as the beamfocusing parameters in the set of beamfocusing parameters, between the minimum and the maximum beamfocusing parameter, including or excluding the minimum and/or maximum values. Note that the minimum and/or maximum beamfocusing parameter may be pre-configured, such as the minimum being preconfigured to 0.

In another example, the determination may be additionally based on a quantization level. The WTRU may determine the subset as the beamfocusing parameters between the minimum and maximum, and with a quantization according to the quantization level.

In an example, the quantization level may be in the form of a beamfocusing parameter index step size n. For example, the WTRU may determine the subset as every n:th beamfocusing parameter from the set of beamfocusing parameters between the minimum and the maximum.

In an example, the quantization level may be in the form of, or determined from, a number of beamforming parameters in the subset of beamforming parameters.

For example, if Sⱼ denotes the number of beamforming parameters in a j^{th} subset, the WTRU may determine the beamfocusing parameter in the subset to be the Sⱼ uniformly distributed parameters between the minimum and maximum beamfocusing parameters, e.g., with or without rounding, wherein the rounding may be towards the closest beamfocusing parameter in the set of beamfocusing parameters.

In another example, the WTRU may determine a beamfocusing parameter index step size n based on the minimum, maximum, and number of beamfocusing parameters Sⱼ. For example, the WTRU may determine n as (iₘₐₓ−iₘᵢₙ+1)/Sⱼ, wherein iₘᵢₙ and iₘₐₓ are the indices of the minimum and maximum within the set of beamfocusing parameters, respectively, and where the ratio may be additionally rounded (down/up/closest) to determine an integer n.

The WTRU may be configured with the same or different Sⱼ, n, and/or other quantization level configuration, for different subsets j. The WTRU may also be configured with the same or different iₘᵢₙ, iₘₐₓ, and/or other minimum/maximum beamfocusing parameter configuration, for different subsets j.

In some cases, a subset may equal the set of beamfocusing parameters.

In some cases, the WTRU may determine a beamfocusing parameter, e.g., the minimum and/or maximum beamfocusing parameter(s), based on a received configuration of one or more distances, e.g., a distance between a TRP and the WTRU, and/or the distance between a TRP and a scatterer.

In some cases, subset properties for determination of a subset of beamfocusing parameters may be configured for an object of association (e.g., a subset of FF beams). The WTRU may determine a subset based on the subset properties and associate the subset with the object of association. For different objects of association, e.g., subsets of FF beams, with different configured subset properties, the WTRU may determine different subsets of beamfocusing parameters that are associated with the objects of association.

In some cases, one or more of minimum beamfocusing parameter, maximum beamfocusing parameter, and/quantization levels, may be determined by the WTRU based on one or more measurements, at least partly.

The WTRU may determine one or more distance parameters, e.g., based on measurement(s) on reference signal(s) (RS(s)), WTRU positioning, WTRU sensing of the environment, etc. For example, the WTRU may determine a distance between a TRP and the WTRU, and/or between a TRP and a scatterer. WTRU measurement may also comprise channel estimation upon RS reception.

In an embodiment, the WTRU may determine a beamfocusing parameter based on a distance parameter. A distance parameter value may be associated to a beamfocusing parameter value based on a configured and/or pre-configured formula, wherein the formula may comprise one or more configurable parameters. The WTRU may determine a beamfocusing parameter from the set of beamfocusing parameters based on a distance parameter, e.g., as the beamfocusing parameter in the set of beamfocusing parameters that is closest to a beamfocusing parameter value associated with, e.g., using a formula, the determined distance.

The WTRU may use the beamfocusing parameter determined based on a determined distance to determine a minimum, maximum, and/or center beamfocusing parameter for a subset of beamfocusing parameters.

In an example, the WTRU may determine a minimum beamfocusing parameter for a subset based on a determined distance between a TRP and a scatterer. This may be reasonable, for instance, if the scatterer obstructs the communication channel, e.g., in a particular direction, such that smaller beamfocusing parameters, e.g., corresponding to larger distances, might not be expected.

In another example, the WTRU may determine a maximum beamfocusing parameter for a subset based on a determined distance between a TRP and the WTRU. This may be reasonable, for instance, if the largest beamfocusing parameters, e.g., corresponding to smaller distances, are unlikely due to the distance.

In yet another example, the WTRU may determine a center, or similar, beamforming parameter for a subset based on a determined distance between a TRP and the WTRU, or between a TRP and a scatterer. This may be reasonable, for instance, since beamfocusing parameters corresponding to both smaller and larger distances than the determined distance may be included in the subset, thereby readily supporting WTRU mobility towards or away from the TRP, or beamfocusing parameter selection with greater accuracy than the accuracy of the determined distance. The center beamfocusing parameter may be the beamfocusing parameter in the set of beamfocusing parameters closest to the beamfocusing parameter associated with the distance, e.g., as described above. The WTRU may then determine the remaining parameters in the subset, if any, the any combination of minimum beamfocusing parameter, maximum beamfocusing parameter, and/or quantization level, e.g., as described above. For example, the WTRU may use a step size n, and/or subset size Sⱼ, which may be configurable, to determine the parameters in the subset. For example, if Sⱼ is odd, the WTRU may include Sⱼ/2 parameters that are smaller than the center parameter and Sⱼ/2 parameters that are larger than the center parameter. For example, if Sⱼ is even, the WTRU may include └Sⱼ/2┘ parameters that are smaller (or larger) than the center parameter and ┌Sⱼ/2┐ parameters that are larger (or smaller) than the center parameter. The smaller/larger values to be included in the subset may be the parameters closest (in magnitude, or in parameter index) to the center parameter, but separated with a step size n (e.g., n=1, 2, 3, or 4, etc.). In an example, both └Sⱼ/2┘ and ┌Sⱼ/2┐ may be included in the set, with smaller parameters below └Sⱼ/2┘ being included, if any, with a step n, and larger parameters above ┌Sⱼ/2┐ being included, if any. If all smaller parameters cannot be included in the set since the smallest parameter in the set of beamfocusing parameters, e.g., 0, was already included, a corresponding number of additional larger parameters may be included in the set. Correspondingly, if all larger parameters cannot be included in the set since the largest parameter in the set of beamfocusing parameters was already included, a corresponding number of additional smaller parameters may be included in the set.

About determination of beamfocusing parameter subset associations, the WTRU may determine the subsets of beamfocusing parameters in the set of subsets of beamfocusing parameters, e.g., based on the description above. The WTRU may associate a subset with (or map a subset to) one or more objects of association, e.g., any of: one or more FF beams, one or more subsets of FF beams, one or more angles, one or more ranges of angles, one or more distances, one or more ranges of distances, one or more regions, and one or more FF beam characteristics, e.g., beam(s) corresponding to a LoS path, beam(s) corresponding to NLOS path, etc.

The WTRU may associate different subsets of beamfocusing parameters with different one or more objects of association, e.g., different subsets of FF beams. The association(s) may be explicitly configured. The WTRU may also determine the association(s) based on one or more rules, e.g., as described below.

The association of subsets with FF beams may be based on an FF beam magnitude/amplitude determined by the WTRU. For instance, a first subset of beamfocusing parameters, e.g., a large subset corresponding to high resolution, may be associated with an FF beam with high magnitude/amplitude, while a second subset of beamfocusing parameters, e.g., a small subset corresponding to low resolution, may be associated with an FF beam with low magnitude/amplitude. It may be beneficial to use more reporting bits for the beamfocusing parameter for a strong FF beam than for a weak FF beam.

In one example, the number of determined subsets of beamfocusing parameters is the same as the number of objects of association. If so, the WTRU may determine a 1-to-1 association between subsets and objects, e.g., based on an order of subsets given by the beamfocusing parameter subset indices, and an order of the objects of association such as given by corresponding indices.

In the example that the object of association may be an FF beam, the FF beams may be ordered by an FF beam index, which may be a combination of multiple indices, such as a horizontal and a vertical FF beam index. The 1-to-1 association between subsets and FF beams may be based on the subset index and the FF beam index, e.g., smallest subset index associated with smallest or largest FF beam index, etc.

Similarly, other objects of association, such as subset of FF beam, angle, range of angles, distances, range of distances, regions, etc., may be ordered based on a corresponding index, such as beam subset index, angle index, angle range index, distance index, distance range index, region index, etc.

In various examples, the object of association may be a combination of multiple of the objects described above. Example objects of association may include an FF beam and a distance, an FF beam and a distance range, an FF beam and a region, a subset of FF beams and a distance, a subset of FF beams and a distance range, a subset of FF beams and a region, an angle and a distance, an angle and a distance range, an angle and a region, a range of angles and a distance, a range of angles and a distance range, or a range of angles and a region,

In the case of such objects of association with multiple components, e.g., a subset of FF beams and a region, the multiple components may be associated with component indices, e.g., beam subset index and region index. A single index may be constructed based on the multiple component, by indexing the components in an order. For instance, with indexing starting from 0, joint index=(beam subset index−1)+(region index−1)*(beam subset size), wherein the beam subset size may equal the maximum beam subset index−1.

In some cases, the WTRU may determine a single subset of beamfocusing parameters, e.g., for a context. Due to the single subset, associations with objects of association might not be relevant. Or, from a different perspective, all objects of association may be associated with the same (single) subset of beamfocusing parameters.

In various embodiments, a WTRU may (e.g., at first step) determine the set of, e.g., multiple, subsets of beamfocusing parameters and corresponding associations. The WTRU may (e.g., as a second step) determine an object of association, e.g., through measurement(s). The WTRU may (e.g., as a third step) select a subset from the set of subsets of beamfocusing parameter, e.g., based on the determined object of association.

In other various embodiments, a WTRU may (e.g., at first step) determine an object of association, e.g., an FF beam, for instance through measurement(s). The WTRU may (e.g., as a second step) determine a subset of beamfocusing parameters associated with the determined object of association. This approach may avoid the determination of all subsets in the set of beamfocusing parameters in the first step, while only determining the useful subset, e.g., the subset associated with the determined object of association.

About WTRU selection of a subset of beamfocusing parameters, the WTRU may determine a subset from which it selects a beamfocusing parameter required for constructing a NF spot beam from a FF beam. The WTRU may select a subset based on angle information of the FF beam, rough distance estimation, etc. As a first example, the WTRU may select a subset of beamfocusing parameters from configured angle-based subsets of beamfocusing parameters associated with a selected FF beam to construct a NF beam. As a second example, the WTRU may select a subset of beamfocusing parameters from region-based subsets of beamfocusing parameters. As a third example, the WTRU may select a subset of beamfocusing parameters based on estimating a rough distance and/or angle.

In an embodiment, a WTRU may construct/determine a spot beam from a FF beam by applying a beamfocusing parameter to this FF beam where the WTRU may select a subset of beamfocusing parameters (e.g., a constructed or a configured subset of beamfocusing parameters) from which it selects the beamfocusing parameter to construct/determine a spot beam based on one or any combination of the following examples.

The WTRU may select a subset of beamfocusing parameters based on angular direction of a FF beam used to construct a NF spot beam. In one example, the WTRU may select a subset of beamfocusing parameters associated with any of a FF beam used to construct/to determine a NF beam, a subset of FF beams including a FF beam used to construct/to determine a NF beam, and an angle range including a FF beam used to construct/to determine a NF beam.

In another example, the WTRU may select a subset of beamfocusing parameters through determining a distance. For example, the WTRU may determine a distance between a TRP and the WTRU. For example, the WTRU may determine a distance between a TRP and a scatterer.

Then, the WTRU may select a subset of beamfocusing parameters based on the estimated distance. For instance, the WTRU may select a subset of beamfocusing parameters associated with a distance range to which the estimated distance between a TRP and the WTRU belongs, e.g., in case the WTRU selects a beamfocusing parameter for a FF beam corresponds to LoS path between the WTRU and the TRP. For instance, the WTRU may select a subset of beamfocusing parameters associated with a distance range to which the estimated distance between a TRP and a scatterer belongs, e.g., in case the WTRU selects a beamfocusing parameter for a FF beam corresponds to NLOS path between the WTRU and the TRP

In one example, the WTRU may select a subset of beamfocusing parameters through estimating its angle with a TRP. The WTRU may determine its angle with a TRP, e.g., based on measurement(s) on RS(s), WTRU positioning, WTRU sensing or the environment, etc.

For instance, the WTRU may select a subset of beamfocusing parameters associated with an angle range to which the estimated angle between the WTRU and a TRP belong.

In one example, the WTRU may select a subset of beamfocusing parameters through detecting its region. For instance, the WTRU may detect a region through one or any combination of the following: (i) the WTRU determines a distance between the WTRU and a TRP (e.g., the WTRU may detect a region associated with a distance range to which the determined distance belongs), (ii) the WTRU may determines an angle between the WTRU and a TRP (e.g., the WTRU may detect a region associated with an angle range to which the determined angle belongs), and (iii) the WTRU measures one or more DL RS. (e.g., the WTRU may receive one or more DL RS associated with different regions (e.g., region IDs). The WTRU may measure the different received DL RSs and detect its region ID based on the measured DL RS with highest one or more metrics, e.g., RSRP, SINR, etc.).

Then the WTRU may select a subset of beamfocusing parameter associated with the detected region.

In one example, the WTRU may receive indication for a phase calculation function to be applied for construction of a NF spot beam from a FF beam. For instance, the WTRU may select a subset of beamfocusing parameters associated with a phase calculation function indicated/configured by the NW (e.g., gNB, TRP) to the WTRU.

In one example, the WTRU may select a subset of beamfocusing parameters based on the path characteristics associated with a FF beam. The WTRU may determine an angle between the WTRU and a TRP (e.g., LOS angle) and compare between the determined angle and the associated angle of a FF beam to select a subset of beamfocusing parameters. As a first example, in case a FF beam corresponds to a LOS angle between the WTRU and a TRP, the WTRU may select a subset of beamfocusing parameters associated with one or more LoS spot beams. As a second example, in case a FF beam corresponds to a non-LOS angle between the WTRU and a TRP, the WTRU may select a subset of beamfocusing parameters associated with one or more NLoS spot beams.

In one example, the WTRU may select a subset of beamfocusing parameters that is associated with an activated subset of FF beams.

A benefit of the examples described above may be to reduce the search space for the required beamfocusing parameter to construct/to determine a NF spot beam from a FF beam, e.g., WTRU selects first a subset of beamfocusing parameter and then selects a beamfocusing parameter from the selected subset of beamfocusing parameter. The reduced search space may reduce the WTRU search effort and also the number of bits required to represent the selected beamfocusing parameter in the subsequent CSI reporting

About WTRU selection of beamfocusing parameters, the WTRU may determine a beamfocusing parameter from a selected/constructed subset of beamfocusing parameter. For instance, for a FF beam, the WTRU may select a corresponding beamfocusing parameter from angle-based subset of beamfocusing parameter associated with the FF beam. Alternatively, the WTRU may select the beamfocusing parameter for a FF beam from a selected region-based subset of beamfocusing parameters. The WTRU may select the beamfocusing parameters based on rough estimation of the distance. The below examples describe different methods/embodiments that a WTRU may apply to select a beamfocusing parameter from a set/subset of beamfocusing parameters to construct/to determine a NF spot beam from a FF beam.

In an embodiment, a WTRU may select a beamfocusing parameter from a set/subset of beamfocusing parameters, e.g., using one or any combination of the following examples.

In one example, the WTRU may select a beamfocusing parameter from a set/subset of beamfocusing parameters through determining a distance. For example, the WTRU may determine a distance between a TRP and the WTRU, e.g., to select a beamfocusing parameter for a FF beam corresponding to a LoS path between the WTRU and TRP. For example, the WTRU may determine a distance between a TRP and a scatterer, e.g., to select a beamfocusing parameter for a FF beam corresponding to a Non-LoS path between the WTRU and TRP.

Then, the WTRU may determine a beamfocusing parameter value based on the determined distance and a configured and/or pre-configured formula, e.g., as described in section Error! Reference source not found., wherein the formula may comprise one or more configurable parameters. The WTRU may then select a beamfocusing parameter from a subset/set of beamfocusing parameters based on the determined beamfocusing parameter value, e.g., the WTRU selects a beamfocusing parameter that is closest to a determined beamfocusing parameter value using a configured/pre-configured formula and the determined distance.

In one example, the WTRU may select a beamfocusing parameter based on latest selected beamfocusing parameter and WTRU moving direction after selecting/reporting latest beamfocusing parameter. For instance, the WTRU may determine its moving direction, e.g., moving towards a TRP, moving away from a TRP based on any of through positioning and/or sensing mechanism, WTRU determination of its distance with a TRP, and measurement(s) on RS(s), e.g., RSRP, SINR.

For example, the WTRU may compare its previous reference signal received power (RSRP) with a current RSRP. And if the WTRU observes increase in RSRP, the WTRU may determine its moving direction to be WTRU moves towards a TRP. If the WTRU observes decrease in RSRP, the WTRU may determine its moving direction to be WTRU moves away from a TRP. Similarly, the WTRU may compare its distance with TRP with a previous measured distance with the TRP, and if WTRU observes decrease in distance, the WTRU may determine its moving direction to be WTRU moves towards a TRP. If the WTRU observes increase in distance, the WTRU may determine its moving direction to be WTRU moves away from a TRP.

A WTRU may select a beamfocusing parameter based on the latest selected beamfocusing parameter and the WTRU moving direction.

As a first example, the WTRU may select a beamfocusing parameter larger than latest selected beamfocusing parameter if the WTRUmoves toward a TRP. E.g., the WTRU may reduce the search space of a beamfocusing parameter in a set or a subset of beamfocusing parameters through searching only for beamfocusing parameters whose values are greater than latest determined beamfocusing parameter. The WTRU may select current and previous parameter from same or different subsets of beamfocusing parameter.

As a second example, the WTRU may select a beamfocusing parameter smaller than latest selected beamfocusing parameter if the WTRU moves away from a TRP. E.g., the WTRU may reduces the search space of a beamfocusing parameter in a set or a subset of beamfocusing parameters through searching only for beamfocusing parameters whose values are smaller than latest determined beamfocusing parameter. The WTRU may select current and previous parameter from same or different subsets of beamfocusing parameter.

As a third example, the WTRU may receive a parameter indicating the number of beamfocusing parameters considered in a search space (e.g., size of search space) for selecting a beamfocusing parameter. For instance, the WTRU may determine the search space for a beamfocusing parameter based on latest determined beamfocusing parameter and indicated size of search space by the NW.

In details, more particularly, as a non-limited example, the WTRU may receive indication for an odd search space size S′ⱼ. The WTRU may include previous beamfocusing parameter in the search space, e.g., in case the WTRU selects beamfocusing parameter from same set/subset of beamfocusing parameters as the one used to select previous beamfocusing parameter. Also, the WTRU may include in the search space closest (in magnitude, or in parameter index) ((Sⱼ−1)/2) parameters to previous beamfocusing parameter that are smaller than it and closest (in magnitude, or in parameter index) ((Sⱼ−1)/2) parameters to previous beamfocusing parameter that are larger than it.

In details, more particularly, as another non-limited example, the WTRU may receive indication for an odd search space size S′ⱼ. The WTRU may includes closest (in magnitude) beamfocusing parameter to previous beamfocusing parameter in the search space, e.g., in case the WTRU selects beamfocusing parameter from different subset of beamfocusing parameters than the one used to select previous beamfocusing parameter. Also, the WTRU may include in the search space closest (in magnitude) ((Sⱼ−1)/2) parameters to previous beamfocusing parameter that are smaller than it and closest (in magnitude) ((Sⱼ−1)/2) parameters to previous beamfocusing parameter that are larger than it.

In details, more particularly, as another non-limited example, the WTRU may receive indication for an even search space size S′ⱼ. For example, if Sⱼ is even, the WTRU may include in the search space closest (in magnitude, or in parameter index) ((Sⱼ−1)/2) parameters to previous beamfocusing parameter that are equal to or smaller than it and closest (in magnitude, or in parameter index) to previous beamfocusing parameter ((Sⱼ−1)/2) parameters that are equal to or larger than it. The WTRU may not repeat same beamfocusing parameter n the search space;

In one example, the WTRU may consider all beamfocusing parameters belonging to a subset/set of beamfocusing parameters in the beamfocusing parameter search space.

In an embodiment, the WTRU may select a beamfocusing parameter from a beamfocusing parameter search space through performing antenna port aggregation to reconstruct a channel matrix (a channel including estimated channel of different antenna ports at a TRP) and applying one or any combination of the following two examples.

In a first example, the WTRU may apply different beamfocusing parameters from a beamfocusing parameter search space to a FF beam to construct different NF beams. Also, the WTRU may performs singular value decomposition (SVD) to the channel matrix. Then, the WTRU may evaluates cross correlation between constructed NF beams and the right singular vector(s) of the channel matrix. The WTRU may select a beamfocusing parameter that constructs a NF beam with highest cross correlation with the right singular vector(s) of the channel matrix;

In a second example, the WTRU may apply different beamfocusing parameters from a beamfocusing parameter search space to a FF beam to construct different NF beams and use the constructed NF beams to calculate one or more metrics (e.g., channel capacity). Then, the WTRU may select a beamfocusing parameter resulting in the best calculated metric, e.g., highest channel capacity.

In an embodiment, a WTRU may select a NF beam (e.g., a FF beam and its corresponding beamfocusing parameter, a FF beam belonging to an activated subset of FF beams) through performing antenna port aggregation to reconstruct a channel matrix (a channel including estimated channel of different antenna ports at a TRP) and applying one or any combination of the following four non-limited examples.

As a first example, for one or more FF beams, the WTRU may apply different beamfocusing parameters from the corresponding beamfocusing parameter search space to construct one or more NF beams. Also, the WTRU may perform singular value decomposition (SVD) to the channel matrix. Then, the WTRU may evaluate cross correlation between constructed NF beams and the right singular vector(s) of the channel matrix. The WTRU may select a NF beam (a FF beam and a corresponding beamfocusing parameter) with highest cross correlation with the right singular vector(s) of the channel matrix.

As a second non-limited example, for one or more FF beams, the WTRU may apply different beamfocusing parameters from the corresponding beamfocusing parameter search space to construct one or more NF beams. Then the WTRU may use the constructed NF beams to calculate one or more metrics (e.g., channel capacity, spectral efficiency, channel quality indicator, etc.). Then, the WTRU may select a NF beam (a FF beam and a corresponding beamfocusing parameter) resulting in the best calculated metric, e.g., highest channel capacity;

As a third non-limited examples, for one or more FF beams belonging to an activated subset of FF beams, the WTRU may apply different beamfocusing parameters from the corresponding beamfocusing parameter search space to construct one or more NF beams. Also, the WTRU may perform singular value decomposition (SVD) to the channel matrix. Then, the WTRU may evaluate cross correlation between constructed NF beams and the right singular vector(s) of the channel matrix. The WTRU may select a NF beam (a FF beam and a corresponding beamfocusing parameter) with highest cross correlation with the right singular vector(s) of the channel matrix.

As a fourth example, for one or more FF beams belonging to an activated subset of FF beams, the WTRU may apply different beamfocusing parameters from the corresponding beamfocusing parameter search space to construct one or more NF beams. Then the WTRU may use the constructed NF beams to calculate one or more metrics (e.g., channel capacity, spectral efficiency, channel quality indicator, etc.). Then, the WTRU may select a NF beam (a FF beam and a corresponding beamfocusing parameter) resulting in the best calculated metric, e.g., highest channel capacity.

About WTRU reporting/indication of determined NF beam, the WTRU may report a determined NF beam through reporting one or more of a selected FF beam used to construct/to determine the NF beam, a selected subset of beamfocusing parameters, and a selected beamfocusing parameter. Reporting here can be transmitting information indicating. After the WTRU constructs/selects a NF spot beam, the WTRU may report it to the gNB (e.g., TRP). The WTRU may report one or more of the selected FF beam information, the selected subset of beamfocusing parameters information, the selected beamfocusing parameter information etc. to the gNB to indicate the determined NF beam. The WTRU may transmit a report indicating one or more of the selected FF beam information, the selected subset of beamfocusing parameters information, the selected beamfocusing parameter information etc. to the gNB (e.g., TRP, BS) to indicate the determined NF beam.

The WTRU may indicate the selected FF beam through reporting one or any combination of the following. The WTRU may report the FF beam that is selected to be used for constructing the NF spot beam to the gNB. In one example, the WTRU may report (e.g., may transmit information indicating) the beam index for the selected FF beam. In another example, the WTRU may report the horizontal and vertical beams indices for the selected FF beam. In yet another example, the WTRU may report the angular information, e.g., range index of the angle range, index of the upper bound angle of the angle range, index of the lower bound angle of the angle range, quantization level, etc., for the selected FF beam. An index here can be a local index of the selected FF beam within a configured subset of FF beams. Or the index here can be the global index configured for the selected FF beam, e.g., index of the selected FF beam in a configured codebook of FF beams.

In some scenario, a WTRU may be configured with multiple subsets of FF beams. The WTRU may report the beam subset index to indicate the selected subset of FF beams. In another example, the WTRU may report the angular information associated with the selected subset of FF beams to indicate the selected subset of FF beams. The WTRU may report range index of the angle range, index of the upper bound angle of the angle range, index of the lower bound angle of the angle range, quantization level, etc., that is associated with the selected subset of FF beams to the gNB to indicate the selected subset of FF beams. The WTRU may also report the selected subset of beamfocusing parameters to the gNB (e.g., TRP) to indicate the associated subset of FF beams or the associated FF beam that has been selected.

The WTRU may indicate the selected subset of beamfocusing parameters through reporting one or any combination of the following.

The WTRU may report the selected subset of FF beams or the selected FF beam or an angle range index to the gNB to indicate the associated subset of beamfocusing parameters that has been selected (e.g., implicit indication of the selected subset of beamfocusing parameters). The WTRU may indicate a binary bit to indicate whether an extended subset of beamfocusing parameters or a reduced subset of beamfocusing parameters is selected. The WTRU may report a parameter subset index to indicate the selected subset of beamfocusing parameters.

The WTRU may indicate the distance associated with the selected subset of beamfocusing parameters, e.g., the index of the distance, the range index of the distance range, index of the upper bound distance of the distance range, index of the lower bound distance of the distance range, etc., to gNB (e.g., TRP) to indicate the associated subset(s) of beamfocusing parameters that has been selected.

The WTRU may indicate the region associated with the selected subset of beamfocusing parameters, e.g., the index of the region, the index of the DL RS associated with the region, the range index of the distance range associated with the region, the range index of the angle range associated with the region, or a combination of the range index of angle range and range index of distance range associated with the region, etc., to indicate the associated subset(s) of beamfocusing parameters that has been selected.

The WTRU may indicate the selected subset of beamfocusing parameters through reporting the global parameter subset index indicating the selected subset of beamfocusing parameters, wherein the global parameter subset index may be applicable to a context. In another example, the WTRU may indicate the selected subset of beamfocusing parameters through reporting the local parameter subset index.

As a first non-limited example, the local parameter subset index may indicate the selected subset of beamfocusing parameters from the different subsets of beamfocusing parameters associated with the reported FF beam. As a second non-limited example, the local parameter subset index may indicate the selected subset of beamfocusing parameters from the different subsets of beamfocusing parameters associated with the reported region.

The WTRU may indicate the selected beamfocusing parameter through reporting one or any combination of the following.

The WTRU may report the beamfocusing parameter that is selected to be used for constructing the NF spot beam to the gNB. The WTRU may report the beamfocusing parameter index for the selected beamfocusing parameter.

The WTRU may report the global index indicating the selected beamfocusing parameter from the configured set of beamfocusing parameters. Alternatively, the WTRU may report the local index indicating the selected beamfocusing parameter from the selected subset of beamfocusing parameters where the WTRU may report the selected subset of beamfocusing parameters using one or any combination of above-mentioned solutions.

The WTRU may indicate the distance associated with the selected beamfocusing parameter, e.g., the index of the distance, the range index of the distance range, index of the upper bound distance of the distance range, index of the lower bound distance of the distance range, etc., to gNB to indicate the selected beamfocusing parameter.

The WTRU may indicate the region associated with the selected beamfocusing parameter, e.g., the index of the region, the index of the DL RS associated with the region, the range index of the distance range associated with the region, the range index of the angle range associated with the region, or a combination of the range index of the angle range and range index of the distance range associated with the region, etc., to indicate the selected beamfocusing parameter. The WTRU may report the selected beamfocusing parameter in the wideband PMI information field.

Note that a determined and reported NF beam (e.g., FF beam and beamfocusing parameter for constructing the determined/selected NF beam) may correspond to a NF precoder (e.g., PMI in CSI report).

An alternative approach to understanding the various embodiments presented herein is that the WTRU may either determine or be configured with a codebook of NF beams. In one example, a codebook of NF beams may be constructed based on a codebook of FF beams and a set of beamfocusing parameters. Each NF beam in the codebook of NF beams is linked to both an FF beam from the codebook of FF beams and a beamfocusing parameter from the set of beamfocusing parameters.

A codebook of NF beams may be represented as the union of one or more subsets of NF beams where each subset of NF beams may include one or more NF beams. Each subset of NF beams may associated with a subset of FF beams and/or a subset of beamfocusing parametersf or constructing/determining the NF beams within the subset of NF beams. For instance, a NF beam in a subset of NF beams may be constructed using a FF beam from the associated subset of FF beams with the subset of NF beams and a beamfocusing parameter from the associated subset of beamfocusing parameters with the subset of NF beams.

In an embodiment, a WTRU may be configured with a FF-based codebook, multiple subsets of FF beams, and multiple angle-based subsets of beamfocusing parameters. The WTRU may determine a NF beam through selecting a FF beam and at least one beamfocusing parameter from the angle-dependent subset of beamfocusing parameters that is associated with the angle corresponding to the selected FF beam. The WTRU may indicate a determined NF beam to the NW through reporting the corresponding selected FF beam and the at least one beamfocusing parameter.

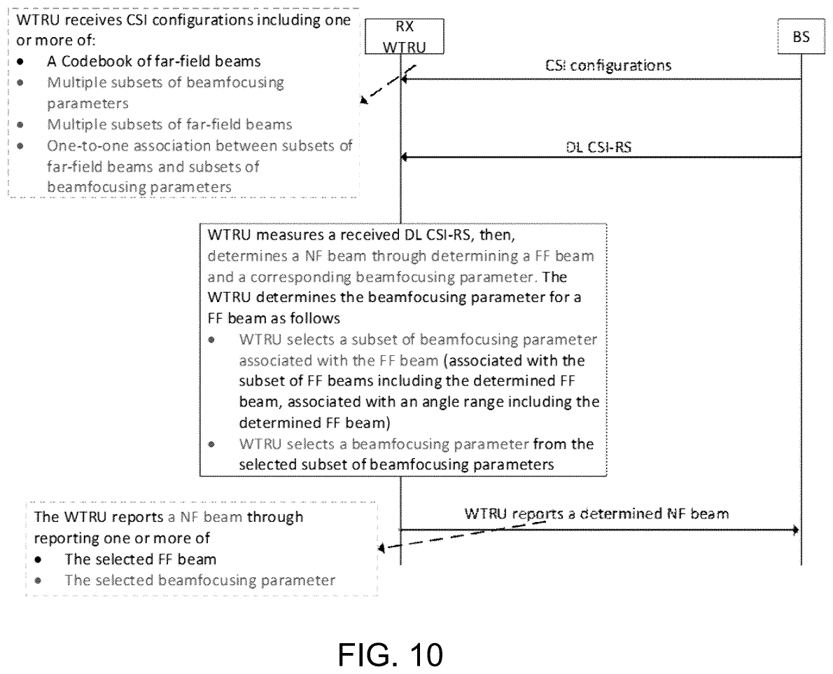

Referring to FIG. 10, in an embodiment, a method, implemented in a WTRU, may comprise a step wherein the WTRU may receive a CSI configuration, including one or more of a codebook of FF beams, multiple subsets of beamfocusing parameters wherein each subset is associated with an index, multiple subsets of FF beams wherein each subset of FF beams includes one or more FF beams (e.g., one or more indices of FF beams), and a one-to-one association between subsets of beamfocusing parameters and subsets of FF beams.

The method may comprise a step wherein the WTRU may receive DL CSI-RS.

The method may comprise another step wherein the WTRU may measure received DL CSI-RS and may determine a NF beam through determining a FF beam and a corresponding beamfocusing parameter.

The WTRU may determine the beamfocusing parameter for a FF beam as follows: (i) the WTRU selects a subset of beamfocusing parameter associated with the FF beam (associated with the subset of FF beams including the determined FF beam); and (ii) the WTRU selects a beamfocusing parameter form the selected subset of beamfocusing parameters.

The method may comprise a step wherein the WTRU may determine and reports a NF beam through reporting any of the selected FF beam, and the selected beamfocusing parameter from the selected subset of beamfocusing parameters.

In an embodiment, a WTRU may be configured with FF-based codebook and one or more angles-based beamfocusing parameters and corresponding number of quantization levels. The WTRU may construct/determine a subset of beamfocusing parameters using one or more of the configured parameters. The WTRU may determine and may report a NF beam through selecting/reporting a FF beam and a corresponding beamfocusing parameter from a constructed/determined subset of beamfocusing parameters.

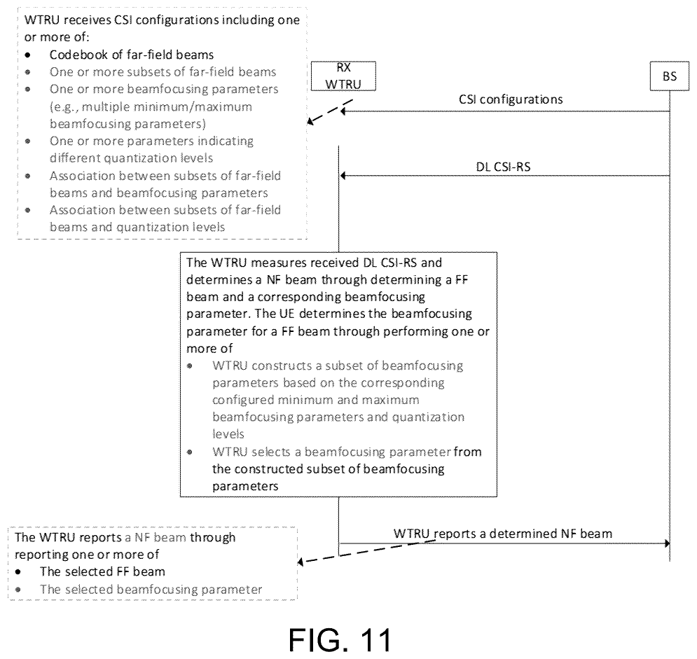

Referring to FIG. 11, in an embodiment, a method, implemented in a WTRU, may comprise a step wherein the WTRU may receive a CSI configuration, which may include any of a codebook of FF beams, one or more beamfocusing parameters (e.g., different minimum and maximum beamfocusing parameters), one or more parameters indicating different number of quantization levels, one or more subsets of FF beams, association between subsets of FF beams and beamfocusing parameters, and association between subsets of FF beams and quantization levels.

The method may comprise a step wherein the WTRU may receive DL CSI-RS.

The method may comprise a step wherein the WTRU may measure received DL CSI-RS and may determine a NF beam through determining a FF beam and a corresponding beamfocusing parameter.

The WTRU may determine the beamfocusing parameter for the determined FF beam through performing one or more of the following: (i) the WTRU constructs/determines a subset of beamfocusing parameters using the configured minimum, maximum beamfocusing parameters and quantization levels that are associated with the FF beam (e.g., associated with the subset of FF beams including the determined FF beam); and (ii) the WTRU selects a beamfocusing parameter from the constructed subset.

The method may comprise a step wherein the WTRU may determine and may report a NF beam through reporting one or more of the selected FF beam, and the selected beamfocusing parameter from a constructed subset of beamfocusing parameters.

In an embodiment, the WTRU may determine an estimate of distance and/or angle. The WTRU may use the rough estimate of distance and/or angle to select one of the configured region-based or angle-based subsets of beamfocusing parameters. Alternatively, the WTRU may use the estimated distance and/or angle to construct a subset of beamfocusing parameters. Additionally, the WTRU may use the estimated distance to select a beamfocusing parameter for a FF beam from the constructed/selected subset of beamfocusing parameters.

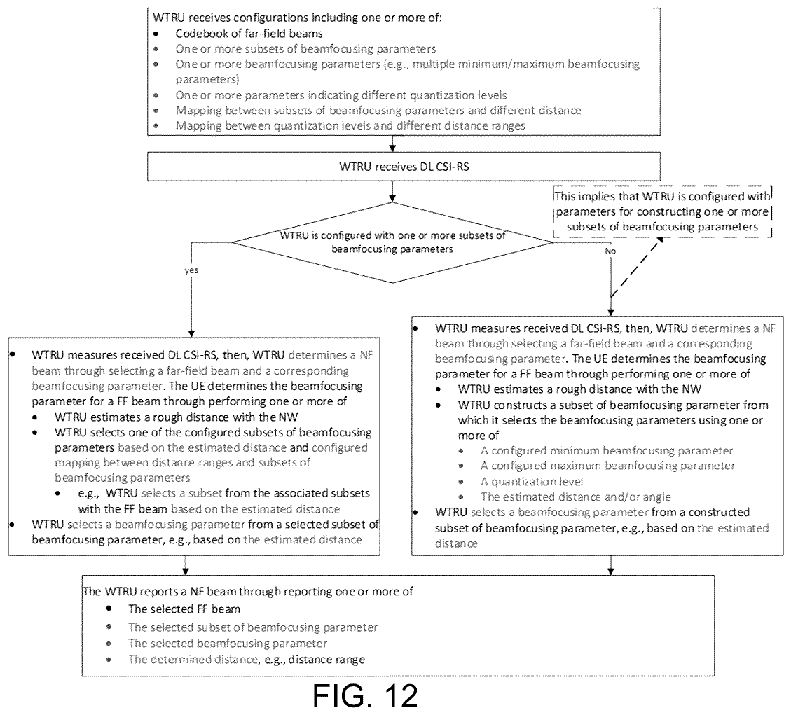

Referring to FIG. 12, in an embodiment, a method, implemented in a WTRU, may comprise a step wherein the WTRU may receive a CSI configuration, which may include any of a codebook of far-field beams, one or more subsets of beamfocusing parameters, one or more beamfocusing parameters (e.g., multiple minimum/maximum beamfocusing parameters), one or more parameters indicating different number of quantization levels, mapping between subsets of beamfocusing parameters and different distance, and mapping between quantization levels and different distance.

The method may comprise a step wherein the WTRU may receive DL CSI-RS.

The method may comprise a step wherein the WTRU may measure received DL CSI-RS, then, the WTRU may determine a NF beam through selecting a far-field beam and a corresponding beamfocusing parameter.

The WTRU may determine the beamfocusing parameter for the selected FF beam through performing one or more of the following: (ii) the WTRU estimates a distance and/or angle, (ii) the WTRU selects one of the configured subsets of beamfocusing parameters based on the estimated distance and configured mapping between distance and subsets of beamfocusing parameters, e.g., the WTRU selects a subset from the associated angle-dependent subsets with the FF beam based on the estimated distance information, (iii) the WTRU constructs/determines a subset from which it selects the beamfocusing parameter using one or more of a configured minimum beamfocusing parameter, a configured maximum beamfocusing parameter, a quantization level, and the estimated distance and/or angle, (iv) the WTRU selects a beamfocusing parameter from the selected/constructed subset of beamfocusing parameter, e.g., based on the estimated distance.

The method may comprise a step wherein the WTRU may determine and may report a NF beam through reporting one or more of the selected FF beam, the Selected subset of beamfocusing parameters, the selected beamfocusing parameter from the selected subset of beamfocusing parameters, and the determined distance, e.g., distance range.

In an embodiment, the WTRU may be configured with a first codebook (e.g., codebook of FF precoders), a second codebook (a codebook of correction factors), and association between every precoder in the first codebook and correction factors in the second codebook. The WTRU may determine a refined precoder through selecting a precoder from the first codebook and a correction factor from the subset of correction factors associated with the selected precoder from the first codebook. The WTRU may report the determined augmented precoder through reporting the information about the selected precoder from the first codebook and the selected correction factor from the second codebook.

In an embodiment, a method implemented in a WTRU, for refining a precoder, may comprise a step wherein the WTRU may receive a CSI configuration, including any of a CSI-configuration, e.g., aperiodic CSI-RS, a first codebook (e.g., codebook of FF precoders), a second codebook (e.g., codebook of phase correction precoders), and an association information, by which, every precoder in the first codebook is associated with at least one phase correction precoder in the second codebook.

The method may comprise a step wherein the WTRU may receive a downlink control information (DCI) to trigger an aperiodic CSI measurement on the configured downlink (DL) CSI—

The method may comprise a step wherein, based on the received DL CSI-RS, the WTRU may determine a precoder selected from the first codebook, may identify from the second codebook, a subset of phase correction precoders associated with the determined precoder, and may select one phase correction precoder from the identified subset of correction factors, e.g., through performing additional measurements, e.g., RSRP measurements.

The method may comprise a step wherein the WTRU may report (e.g., transmit, to the network, information indicating) a refined precoder through reporting any of the information, e.g., one or more indices, related to the first determined precoder; and the information, e.g., one or more indices, related to the selected phase correction precoder.

The above method may enable a selection of the right phase correction precoder to be applied to a determined precoder from a first codebook (e.g., FF precoder) for determining a refined precoder (e.g., NF precoder). In other words, the above method may enable a selection of the right beamfocusing parameter (phase correction factor) for a FF beam to construct/to determine a corresponding NF beam.

The above method may reduce the complexity of searching for the right phase correction precoder to be applied to a determined precoder from a first codebook (e.g., a FF precoder) for determining a refined precoder (e.g., NF precoder) wherein the WTRU searches for the right phase correction precoder to be applied to a determined precoder from a first codebook in a subset of phase correction precoders associated with the determined precoder from a first codebook.

In other words, the above method may reduce the complexity of searching for the right beamfocusing parameter for a FF beam wherein the WTRU searches for the beamfocusing parameter in the subset of beamfocusing parameters associated with the determined FF beam.

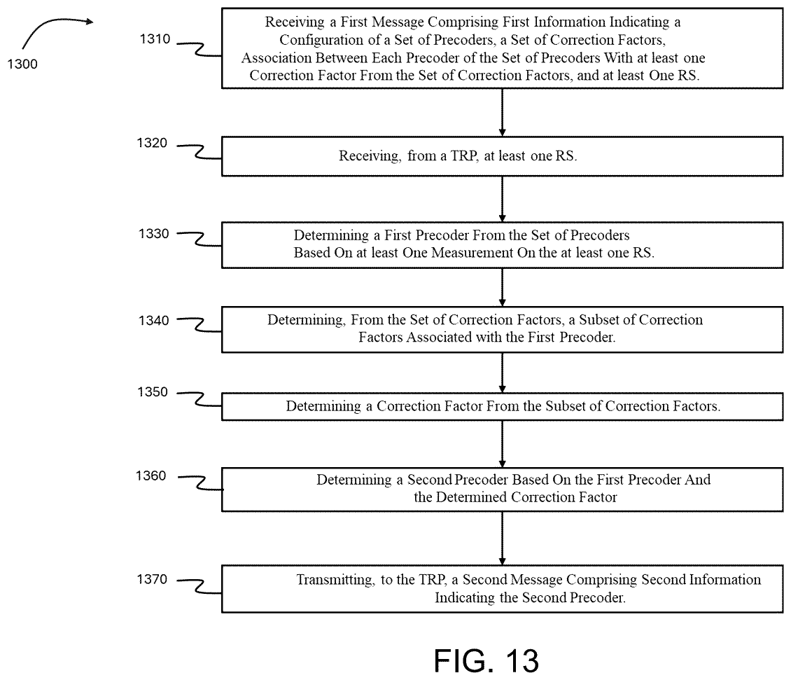

Referring to FIG. 13, a method 1300, implemented in a WTRU, for determining and reporting of a NF beam, may comprise a step wherein the WTRU may receive 1310 a first message comprising first information indicating a configuration of a set of precoders, a set of correction factors, association between each precoder of the set of precoders with at least one correction factor from the set of correction factors, and at least one reference signal (RS). The set of precoders may be included in a first codebook. The set of correction factors may be included in a second codebook. The method 1300 may further comprise a step wherein the WTRU may receive 1320, from a transmission reception point (TRP), at least one RS signal from the configured at least one RS. The method 1300 may further comprise a step wherein the WTRU may determine 1330 a first precoder from the set of precoders based on at least one measurement on the at least one RS. The method 1300 may further comprise a step wherein the WTRU may determine 1340, from the set of correction factors, a subset of correction factors associated with the first precoder. The method 1300 may further comprise a step wherein the WTRU may determine 1350 a correction factor from the subset of correction factors. The method 1300 may further comprise a step wherein the WTRU may determine 1360 a second precoder based on the first precoder and the determined correction factor; and a step wherein the WTRU may transmit 1370, to the TRP, a second message comprising second information indicating the second precoder. The correction factor may comprise a phase correction vector to be applied on the first precoder. The determination of the second precoder may comprise element-wise multiplication between a first precoder vector and the phase correction vector of the correction factor; wherein the first precoder comprises the first precoder vector. The first precoder may be a far field precoder and the second precoder may be a near field precoder. The second information may indicate one or more first indices related to the first precoder and one or more second indices related to the determined correction factor

The correction factor may be determined from the subset of correction factors based on at least one additional measurement on the received at least one RS, wherein the at least one additional measurement may comprise a measurement of reference signal received power.

The method 1300, wherein the first information further indicates one or more subset of correction factors from the set of correction factors, and wherein each subset of correction factors is associated with a distance range between the TRP and the WTRU, may comprise a step wherein the WTRU may determine a distance range between the TRP and the WTRU based on the received at least one reference signal; and a step of determining the subset of correction factors from the set of correction factors based on an association between the determined distance range and the subset of correction factors.

The method 1300, wherein the first information further indicates at least one minimum correction factor, at least one maximum correction factor, at least one quantization level, and association between each precoder of the set of precoders and a minimum correction factor, a maximum correction factor, and a quantization level, may comprise a step wherein the WTRU may determine the subset of correction factors based on the associated minimum correction factor, maximum correction factor, and quantization level with the first precoder.

The method 1300 may further comprise a step wherein the WTRU may determine the subset of correction factors based on a determined distance range between the TRP and the WTRU based on the received at least one reference signal, and based on a minimum or a maximum correction factor, and a quantization level associated with the first precoder.

The first information may further indicate one or more subset of correction factors of the set of correction factors, an association of each correction factor of the subset of correction factors with result of measurement on the at least one RS, and wherein the determination of the correction factor from the set of correction factors may be based on an association of the result of at least one additional measurement with the correction factor.

The configuration may be a channel state information (CSI) configuration, wherein the configuration of the at least one reference signal may be a configuration of a downlink CSI-RS, and wherein receiving at least one RS may comprise receiving a downlink control information (DCI) to trigger an aperiodic CSI measurement on the configured DL CSI-RS.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented in a wireless transmit/receive unit (WTRU) comprising:
receiving a first message comprising first information indicating a configuration of a set of precoders, a set of correction factors, association between each precoder of the set of precoders with at least one correction factor from the set of correction factors, and at least one reference signal (RS);
receiving, from a transmission reception point (TRP), at least one reference signal;
determining a first precoder from the set of precoders based on at least one measurement on the at least one RS;
determining, from the set of correction factors, a subset of correction factors associated with the first precoder;
determining a correction factor from the subset of correction factors;
determining a second precoder based on the first precoder and the determined correction factor; and
transmitting, to the TRP, a second message comprising second information indicating the second precoder.

2. The method of claim 1, wherein the first precoder is a far field precoder and wherein the second precoder is a near field precoder.

3. The method of claim 1, wherein determining the second precoder comprises element-wise multiplication between a first precoder vector and a phase correction vector of the correction factor; wherein the first precoder comprises the first precoder vector.

4. The method of claim 1, comprising:
determining the correction factor from the subset of correction factors based on at least one additional measurement on the received at least one RS.

5. The method of claim 4, wherein the at least one additional measurement comprises a measurement of reference signal received power.

6. The method of claim 1, wherein the second information indicates one or more first indices related to the first precoder and one or more second indices related to the determined correction factor.

7. The method of claim 1, wherein the first information further indicates one or more subset of correction factors from the set of correction factors, and wherein each subset of correction factors is associated with a distance range between the TRP and the WTRU, the method comprising:
determining a distance range between the TRP and the WTRU based on the received at least one reference signal; and
determining the subset of correction factors from the set of correction factors based on an association between the determined distance range and the subset of correction factors.

8. The method of claim 1, wherein the first information further indicates at least one minimum correction factor, at least one maximum correction factor, at least one quantization level, and association between each precoder of the set of precoders and a minimum correction factor, a maximum correction factor, and a quantization level, the method comprising:
determining the subset of correction factors based on an association of a minimum correction factor, a maximum correction factor, and a quantization level with the first precoder.

9. The method of claim 8, comprising:
determining the subset of correction factors based on a determined distance range between the TRP and the WTRU based on the received at least one reference signal, and based on a minimum or a maximum correction factor, and a quantization level associated with the first precoder.

10. The method of claim 1, wherein the first information further indicates one or more subset of correction factors of the set of correction factors, an association of each correction factor of the subset of correction factors with result of measurement on the at least one RS, and wherein the determination of the correction factor from the set of correction factors is based on an association of the result of at least one additional measurement with the correction factor.

11. A wireless transmit/receive unit (WTRU) comprising a processor, a transmitter, a receiver and a memory, configured to:
receive a first message comprising first information indicating a configuration of a set of precoders, a set of correction factors, association between each precoder of the set of precoders with at least one correction factor from the set of correction factors, and at least one reference signal (RS);
receive, from a transmission reception point (TRP), at least one reference signal;
determine a first precoder from the set of precoders based on at least one measurement on the at least one RS;
determine, from the set of correction factors, a subset of correction factors associated with the first precoder;
determine a correction factor from the subset of correction factors;
determine a second precoder based on the first precoder and the determined correction factor; and
transmit, to the TRP, a second message comprising second information indicating the second precoder.

12. The WTRU of claim 11, wherein the first precoder is a far field precoder and wherein the second precoder is a near field precoder.

13. The WTRU of claim 11, wherein determining the second precoder comprises element-wise multiplication between a first precoder vector and a phase correction vector of the correction factor; wherein the first precoder comprises the first precoder vector.

14. The WTRU of claim 11, configured to:
determine the correction factor from the subset of correction factors based on at least one additional measurement on the received at least one RS.

15. The WTRU of claim 14, wherein the at least one additional measurement comprises a measurement of reference signal received power.

16. The WTRU of claim 11, wherein the second information indicates one or more first indices related to the first precoder and one or more second indices related to the determined correction factor.

17. The WTRU of claim 11, wherein the first information further indicates one or more subset of correction factors from the set of correction factors, and wherein each subset of correction factors is associated with a distance range between the TRP and the WTRU, configured to:
determine a distance range between the TRP and the WTRU based on the received at least one reference signal; and
determine the subset of correction factors from the set of correction factors based on an association between the determined distance range and the subset of correction factors.

18. The WTRU of claim 11, wherein the first information further indicates at least one minimum correction factor, at least one maximum correction factor, at least one quantization level, and association between each precoder of the set of precoder and a minimum correction factor, a maximum correction factor, and a quantization level, configured to:
determine the subset of correction factors based on an association of a minimum correction factor, a maximum correction factor, and a quantization level with the first precoder.

19. The WTRU of claim 18, configured to:
determine the subset of correction factors based on a determined distance range between the TRP and the WTRU based on the received at least one reference signal, and based on a minimum or a maximum correction factor, and a quantization level associated with the first precoder.

20. The WTRU of claim 11, wherein the first information further indicates one or more subset of correction factors of the set of correction factors, an association of each correction factor of the subset of correction factors with result of measurement on the at least one RS, and wherein the determination of the correction factor from the set of correction factors is based on an association of the result of at least one additional measurement with the correction factor.
